(19) United States
(12) Patent Application Publication
(10) Pub. No.: US 2026/0105568 A1
(43) Pub. Date: Apr. 16, 2026

(54) HIGH-SPEED SUPER-RESOLUTION IMAGE STEREOSCOPIC VISUALIZATION PROCESSING SYSTEM AND HIGH-SPEED SUPER-RESOLUTION IMAGE STEREOSCOPIC VISUALIZATION PROCESSING PROGRAM

(71) Applicant: ASIA AIR SURVEY CO., LTD., Tokyo (JP)

(72) Inventor: Tatsuro CHIBA, Tokyo (JP)

(73) Assignee: ASIA AIR SURVEY CO., LTD., Tokyo (JP)

(21) Appl. No.: 19/237,620

(22) Filed: Jun. 13, 2025

Related U.S. Application Data
(63) Continuation of application No. PCT/JP2023/044622, filed on Dec. 13, 2023.

(30) Foreign Application Priority Data
Dec. 16, 2022 (JP) 2022-201205

(51) Int. Cl. G06T 3/4053; G06T 3/4007; G06T 5/70; G06T 7/12; G06T 19/20

(52) U.S. Cl. CPC G06T 3/4053; G06T 3/4007; G06T 5/70; G06T 7/12; G06T 19/20; G06T 2207/10012; G06T 2207/10024; G06T 2207/20021; G06T 2219/2012

(57) ABSTRACT

Provided is a high-speed super-resolution image stereoscopic visualization image processing system with a high-speed processing function capable of obtaining an image of unevenness with a fine resolution at high speed. The high-speed super-resolution image stereoscopic visualization image processing system includes a base map database 110, an area definition unit 112, a super-resolution rasterization processor 135, a moving-average unit 134, a plane-rectangular coordinate converter 145, a super-resolution image generator 151, an X-direction adjuster 152, and a display processor 150. For each super-resolution square mesh defined by a cluster of fine square super-resolution fine meshes mbi, an interpolation process is performed. After applying a moving-average process with respect to an interpolated elevation-value zri of each super-resolution fine mesh mbi of the super-resolution square mesh (Mbi) a predetermined number of times, a plane-rectangular super-resolution mesh (Mdi) is generated and a square adjustment super-resolution mesh Mei is generated. Then a super-resolution image is generated.

This application is a continuation of International Application No. PCT/JP2023/044622, filed on Dec. 13, 2023, which claims the benefit of priority of the prior Japanese Patent Application No. 2022-201205, filed on Dec. 16, 2022, the entire contents of which are incorporated herein by reference.

### TECHNICAL FIELD

The present invention relates to a processing system for high-speed super-resolution image stereoscopic visualization.

### BACKGROUND ART

In recent years, the Geospatial Information Authority of Japan (hereinafter referred to as the “Geospatial Information Authority” or “GSI”) has released the Digital Elevation Model (DEM) scheme on the Internet.

Using the DEM scheme, the Geospatial Information Authority has recently has published a red relief image map based on Patent Literature 1.

The outline of the red relief image map encompasses a step of obtaining a slope gradient, an over-ground openness and an under-ground openness using the 5 m-DEM (five-meters interval Digital Elevation Model), and a step of obtaining a ridge-valley value (also called “an elevation-depression degree”) from the slope gradient, the over-ground openness and the under-ground openness, and a step of creating the red relief image map using chroma saturations of red colors assigned to each slope gradient and brightness of red colors assigned to the ridge-valley values.

However, since the red relief image map is a raster image, jaggy (jag) occurs when the red relief image map is enlarged to see the unevenness of the terrain in more detail.

In other words, even when the red relief image map is superimposed on the map of the Geospatial Information Authority, jaggy will be visible by enlarging the map and thus, the image becomes tainted.

A patent for solving this problem is disclosed (Patent Literature 2: Super-resolution stereoscopic visualization processing system).

The super-resolution stereoscopic visualization processing system according to Patent Literature 2 defines, in a plane-rectangular coordinate, a cluster of meshes represented by latitude and longitude of a predetermined area (for example, 1 km×1 km) in a digital elevation model (depending on location, a parallelogram, a longitudinal trapezoid, or a rectangle).

The processing system then calculates a divide-distance which evenly divides a side along an X direction of each of the cluster of the meshes defined in the plane-rectangular coordinate into an odd number other than one.

The processing system then divides a two-dimensional plane (X-Y) of an area corresponding to the predetermined area (for example, 1 km×1 km) by the divide-distance to define super-resolution fine meshes (approximately 55 cm), each having a size of the divide-distance.

The processing system then defines a cluster of meshes (5 m×5 m) in the plane-rectangular coordinate on the two-dimensional plane (X-Y) to determine interpolated elevation-values (example of a division into ninths) obtained by interpolating elevation-values of the super-resolution fine meshes (approximately 55 cm), and generates a square moving-average filter (smoothing meshes (5 m×5 m)) implemented by a cluster of smoothing grid-cells, each of which having a cell size of the divide-distance as the smoothing grid-cells and which are two-dimensionally arranged by the odd number.

The processing system then sequentially designates the super-resolution fine meshes (approximately 55 cm) defined in the two-dimensional plane (X-Y), for each designated super-resolution fine mesh, allocates a central smoothing grid-cell in the square moving-average filter (smoothing meshes (5 m×5 m)) to the super-resolution fine mesh, and defines the moving-average filter (smoothing meshes (5 m×5 m)) in the two-dimensional plane (X-Y).

The processing system then obtains a smoothing elevation-value having been smoothed based on the cluster of the interpolated elevation-value of the cluster of super-resolution fine meshes in the moving-average filter (smoothing meshes (5 m×5 m)) and assigns the smoothing elevation-value to the designated super-resolution fine mesh.

The processing system then specifies the super-resolution fine mesh as a subject point each time the smoothing elevation-values are assigned to the respective super-resolution fine meshes in the two-dimensional plane (X-Y), for each subject point, defines consideration distances from the subject point by the number of super-resolution fine meshes corresponding to the divide-distance to determine an elevation-depression degree within the number of super-resolution fine meshes, and performs a red stereoscopic visualization process of displaying the elevation-depression degree in gradation (for example, in red).

### CITATION LIST

### Patent Literature

[Patent Literature 1] Japanese Patent No. 3670274
[Patent Literature 2] Japanese Patent No. 6692984

### SUMMARY OF INVENTION

### Technical Problem

However, the super-resolution visualization processing system according to Patent Literature 2 performs a red stereoscopic image generation process by converting 5 m-DEM (square meshes) defined using latitude and longitude into plane-rectangular coordinates (to be a trapezoid, a rectangle, or the like), subjecting meshes defined in the plane-rectangular coordinates to TIN bilinear interpolation, determining a moving-average using a square moving-average (smoothing) filter, and performing a smoothing process.

In other words, square meshes (DEM) defined using latitude and longitude are converted into plane-rectangular coordinates (to be a trapezoid, a rectangle, or the like) and the meshes that are trapezoids, rectangles, and the like are subjected to a square moving-average filter.

Converting latitude/longitude coordinates into plane-rectangular coordinates is a complex calculation. However, the conventional super-resolution visualization processing system obtains a super-resolution image by performing interpolation (TIN bilinear interpolation) and moving-average process after first converting, for example, 5 m-DEM of latitude and longitude into plane-rectangular coordinates.

Therefore, due to error, it took a long time to obtain a resulting super-resolution image (processing speed is low). In particular, the larger the area, the more time was required.

The present invention has been made in consideration of the problem described above and an object thereof is to obtain the processing system for high-speed super-resolution image stereoscopic visualization with a high-speed processing function capable of obtaining an image of unevenness with a fine resolution at high speed.

### Solution to Problem

The high-speed super-resolution image stereoscopic visualization processing system according to the present invention includes:
(A). means of obtaining, for each square mesh of a cluster of square meshes of a predetermined area of a digital elevation model, a super-resolution square mesh by defining the square mesh by a cluster of fine square super-resolution fine meshes;
(B). means of performing an interpolation process for each of the super-resolution square meshes and assigning an interpolated elevation-value to each super-resolution fine mesh of the super-resolution square mesh;
(C). means of applying, for each of the super-resolution square meshes, a moving-average process to each super-resolution fine mesh a predetermined number of times, and updating the interpolated elevation-value with the smoothing elevation-value;
(D). means of generating a plane-rectangular super-resolution mesh by defining the super-resolution square mesh after the means (C) by plane-rectangular coordinates; and
(E). means of generating a square super-resolution stereoscopic visualization image based on a plane-rectangular super-resolution fine mesh of the plane-rectangular super-resolution mesh.

### Advantageous Effects of Invention

As described above, according to the present invention, a super-resolution image can be obtained at high speed. In addition, even when a super-resolution image using the DEM scheme is enlarged, jaggies (jag) are not visible and unevenness can be seen three-dimensionally with fine resolution. Further, a grid-like artifact is not generated.

### BRIEF DESCRIPTION OF DRAWINGS

FIG. 1 is a flowchart illustrating an outline of a high-speed super-resolution image stereoscopic visualization processing system according to a present first embodiment.

FIG. 2 is an explanatory diagram of an image obtained by the high-speed super-resolution image stereoscopic visualization processing system according to the present first embodiment.

FIG. 3 is a program block diagram of the high-speed super-resolution image stereoscopic visualization processing system according to the first embodiment.

FIG. 4 is a detailed flowchart (1) of the high-speed super-resolution image stereoscopic visualization processing system according to the present first embodiment.

FIG. 5 is a detailed flowchart (2) of the high-speed super-resolution image stereoscopic visualization processing system according to the present first embodiment.

FIG. 6 is an explanatory diagram of an image displayed by a display processor 150 by downloading the 5 m-DEM and coloring slope gradients.

FIG. 7 is an explanatory diagram of a 9×9 division of a super-resolution square mesh Mbi.

FIG. 8 is an explanatory diagram of a virtual super-resolution mesh Mobi.

FIG. 9 is an explanatory diagram of TIN bilinear interpolation.

FIG. 10 is an explanatory diagram of points when performing a TIN bilinear interpolation process.

FIG. 11 is an explanatory diagram of an example of an image of a result of bilinear interpolation.

FIG. 12 is an enlarged view explaining before bilinear interpolation and after bilinear interpolation.

FIG. 13 is an explanatory diagram of a reason for performing a moving-average process.

FIG. 14 is an explanatory diagram of a moving-average mesh.

FIG. 15 is an explanatory diagram (1) of an effect of a moving-average process.

FIG. 16 is an explanatory diagram (2) of an effect of a moving-average process.

FIG. 17 is an explanatory diagram of DEM data after a super-resolution smoothing process.

FIG. 18 is an explanatory diagram of a trajectory of elevation when not performing and when performing a super-resolution image smoothing process (moving-average).

FIG. 19 is an explanatory diagram of an image after a smoothing process (9×9 box average).

FIG. 20 is an enlarged view explaining an effect of a first moving-average.

FIG. 21 is an enlarged view explaining an effect of a second moving-average.

FIG. 22 is an explanatory diagram of planar-rectangular projection conversion.

FIG. 23 is an explanatory diagram of an image before planar-rectangular coordinate conversion and after projection conversion.

FIG. 24 is an explanatory diagram of X-direction adjustment.

FIG. 25 is an explanatory diagram of an input screen for X-direction adjustment.

FIG. 26 is an explanatory diagram (1) of a super-resolution mesh Mei after square adjustment by X-direction adjustment.

FIG. 27 is an explanatory diagram (2) of the super-resolution mesh Mei after square adjustment by X-direction adjustment.

FIG. 28 is an explanatory diagram of a red stereoscopic image generated from the super-resolution mesh Mei after square adjustment.

FIG. 29 is an explanatory diagram of an array of slope gradients after a smoothing process.

FIG. 30 is an explanatory diagram (1) of resampling in a projection conversion process according to the present embodiment.

FIG. 31 is an explanatory diagram (2) of resampling in a projection conversion process according to the present embodiment.

FIG. 32 is an explanatory diagram (3) of resampling in a projection conversion process according to the present embodiment.

FIG. 33 is an explanatory diagram of an overall generation process of a red stereoscopic image.

FIG. 34 is an explanatory diagram (1) of a generation process of a red stereoscopic image.

FIG. 35 is an explanatory diagram (2) of the generation process of a red stereoscopic image.

FIG. 36 is an explanatory diagram of an overall generation process of a red stereoscopic image of a mountain.

FIG. 37 is a block diagram of a program of a super-resolution image generator 151.

FIG. 38 is a schematic configuration diagram explaining a convexity-emphasis image generator 11 and a concavity-emphasis image generator 12.

FIG. 39 is a schematic configuration diagram explaining an inclination emphasizer 13.

FIG. 40 is an explanatory diagram of a gray scale.

FIG. 41 is an explanatory diagram of a calculation method of an over-ground openness and an under-ground openness of super resolution.

FIG. 42 is an explanatory diagram of a data structure of super-resolution DEM.

FIG. 43 is an explanatory diagram of a super-resolution red stereoscopic image generated based on a conventional super-resolution image visualization processing system.

FIG. 44 is an explanatory diagram of a super-resolution image generated by the high-speed super-resolution image stereoscopic visualization processing system according to the present embodiment.

FIG. 45 is an explanatory diagram of an example of use.

FIG. 46 is a schematic configuration diagram of a second embodiment.

FIG. 47 is an explanatory diagram of generation of smooth contour information Ji.

FIG. 48 is an explanatory diagram of an image of an example of superimposing contours (vectors) of the smooth contour information Ji on a red image not subjected to a smoothing process.

FIG. 49 is an enlarged view of FIG. 48.

FIG. 50 is an explanatory diagram of an image resulting from subjecting contours to a smoothing process using an elevation-value zhi.

FIG. 51 is a diagram synthesizing contours of a 1/25000 map and a red image generated based on 10 m-DEM.

FIG. 52 is an explanatory diagram of an image synthesized with a super-resolution red image created by the high-speed super-resolution image stereoscopic visualization processing system according to the present first embodiment.

FIG. 53 is a schematic configuration diagram of a Lab color-imparted high-speed super-resolution image stereoscopic visualization processing system according to another embodiment.

FIG. 54 is a flowchart (1) of the Lab color-imparted high-speed super-resolution image stereoscopic visualization processing system according to another embodiment.

FIG. 55 is a flowchart (2) of the Lab color-imparted high-speed super-resolution image stereoscopic visualization processing system according to another embodiment.

FIG. 56 is a flowchart (3) of the Lab color-imparted high-speed super-resolution image stereoscopic visualization processing system according to another embodiment.

FIG. 57 is an explanatory diagram by an image during a process of obtaining a Lab color red super-resolution image KLi.

FIG. 58 is a schematic configuration diagram of a Lab color unit 320.

FIG. 59 is an explanatory diagram of a spectrum distribution.

FIG. 60 is a schematic configuration diagram of Lab colorization.

FIG. 61 is a scatter diagram illustrating a relationship between over-ground openness and under-ground openness.

FIG. 62 is a diagram illustrating a screen example of a super-resolution Lab color image Li.

FIG. 63 is a diagram of a screen example (1) of the Lab color red super-resolution image KLi.

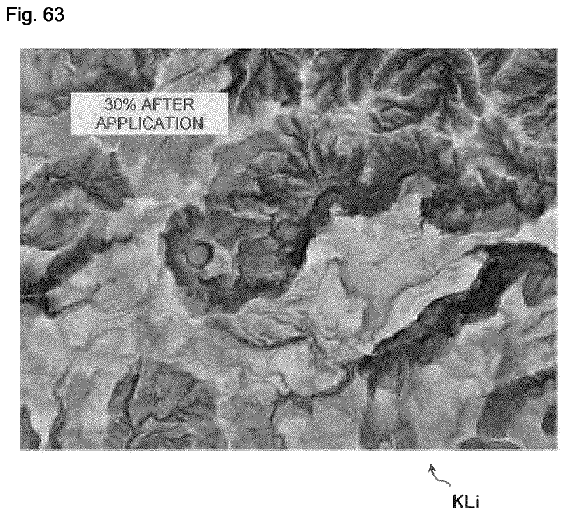

FIG. 64 is a diagram of a screen example (2) of the Lab color red super-resolution image KLi.

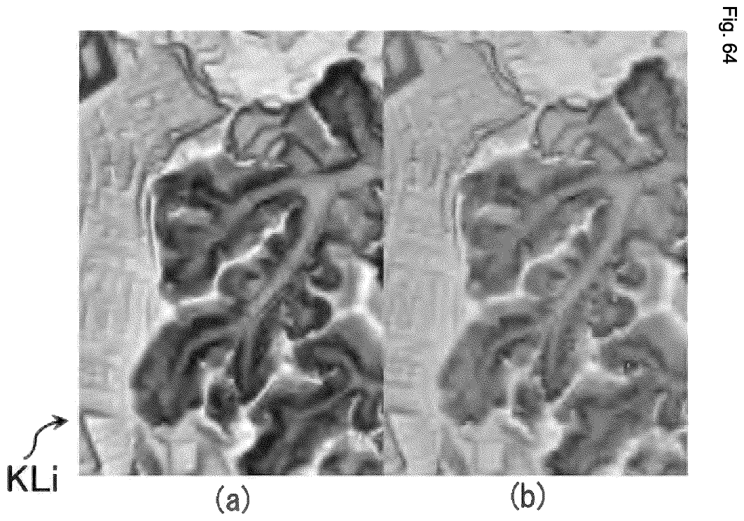

FIG. 65 is a schematic configuration diagram of the third embodiment.

FIG. 66 is an explanatory diagram in a case where resolution of the DEM is reduced and the earth system is taken into consideration.

### DESCRIPTION OF EMBODIMENTS

The embodiments of the present invention described below exemplify apparatuses and methods to embody the technical ideas (structure and arrangement) and the technical ideas of the present invention are not specified to the following. The technical ideas of the present invention may be modified in various ways within the scope of the claims. It should also be noted that the drawings are schematic and the configuration of apparatuses and systems may differ from reality.

In embodiments of the present invention, procedures of obtaining a super-resolution stereoscopic image Ki at high speed will be described using a base map (hereinafter referred to as a 5 m-DEM base map Fa) that is a 5 m-DEM (A: A denotes laser) digital elevation model of the Geospatial Information Authority as an example (alternatively, the base map may represent a 10 m-DEM, a 20 m-DEM, a 50 m-DEM, or a 1 m-DEM).

Although different colors, such as blue, green, yellow-green, and the like may be used for the super-resolution stereoscopic-visualization image Ki (also referred to as a super-resolution red relief image map) depending on target areas, seasons, and the like, a reddish color, such as red, purple, vermilion, orange, yellow, green, and the like will be used in the description of the present embodiments. Note that for oceans, lakes, rivers, and the like, blue, brown, and green are preferably used.

### First Embodiment

An outline of the present first embodiment will be described.
(1) Over-sampling (super-resolution) into nine equal parts (odd number: 1 not included) between points of 5 m-DEM (0.2 seconds of equal latitude and longitude: also referred to as a 5 m-DEM mesh) of a base map (DEM: digital elevation model) of the Geospatial Information Authority of Japan is performed (the number of points increases by a factor of 81 (the number of super-resolution fine meshes is 8×8=64)).

An interpolated elevation-value of the super-resolution fine meshes (squares) is determined by bilinear interpolation.
(2) Next, for all super-resolution fine meshes, 9×9 (the number of super-resolution fine meshes is 8×8=64) box average (two-dimensional moving-average process) is determined to perform smoothing. This is repeatedly performed a plurality of times as necessary (preferably until no jaggies remain).

In addition, (3) a projection conversion into a plane-rectangular coordinate system is performed and an X-direction is adjusted to generate a super-resolution red relief image map. Note that an openness consideration distance is adjusted to be the same as the initial general 5 m-DEM mesh.

In addition, while a DEM (Digital Elevation Model) is defined by assigning latitude, longitude, elevation, and the like to a mesh, in the present embodiment, a DEM mesh will simply be referred to as a mesh and a divided fine mesh (also referred to as a fine grid-cell) will be referred to as a super-resolution fine mesh.

The meaning of “over-sampling (miniaturization) to odd numbers” differs in its definition depending on how representative points are taken.

For example, when representative points are assigned to any of corners of a mesh, a division into odd-numbered parts is performed including a point between two points (latitudinal direction, longitudinal direction).

In addition, when a center of a mesh is adopted as a representative point, division is performed so that the number of super-resolution fine mesh is an odd number. A case where representative points are assigned to any of corners of a mesh will be mainly described.

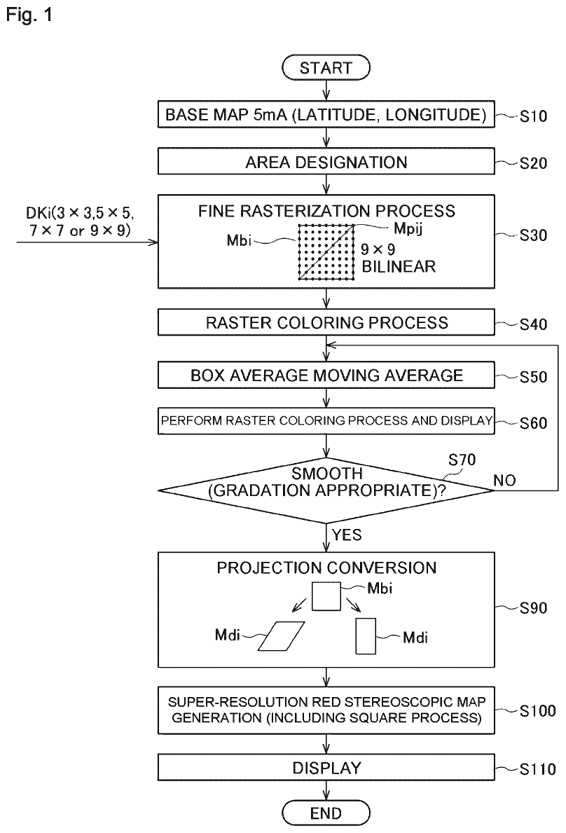

FIG. 1 is a flowchart illustrating an outline of a high-speed super-resolution image stereoscopic visualization processing system according to the present first embodiment. The high-speed super-resolution image stereoscopic visualization processing system is also referred to as a super-resolution image stereoscopic visualization processing system with a high-speed processing function.

As illustrated in FIG. 1, a base map (5 m-DEM (A)) defined using latitude and longitude of the Geospatial Information Authority stored in a memory is extracted (S10).

The 5 m-DEM (square) is a digital elevation model in which the ground surface is divided into a mesh of evenly spaced 5 m (specifically, 5.5×10⁻⁵: 5.5E−⁵) squares (frame) and a center of each square is provided with data such as an elevation-value (Z).

Any area Ei (for example, 1 km×1 km) is designated (S20), and a fine rasterization process is performed in which inside of the area Ei is defined by square super-resolution fine meshes mbi using latitude and longitude as it is and an elevation-value obtained by bilinear interpolation is assigned to each super-resolution fine mesh mbi (S30).

In order to obtain a cluster of super-resolution fine meshes mbi that divide the inside of the 5 m-DEM mesh into an even number of parts, the fine rasterization process divides the 5 m-DEM mesh by a division point number DKi (3×3, 5×5, 7×7, or 9×9: also referred to as the division point number) for performing division into ninths including two corners (latitudinal direction, longitudinal direction) of the 5 m-DEM mesh (this is obtained using latitude and longitude as it is).

A width divided by this division point number DKi is called a division width da and, for example, 9×9 is equivalent to 0.02 seconds in latitude and longitude and 0.55555 m in distance (also called approximately 60 cm). This is obtained using latitude and longitude as it is.

Then, a mesh with a size of 5 m-DEM from the reference point of the area Ei (for example, an origin or a corner of area Ei) (hereinafter referred to as a super-resolution square mesh Mbi) is defined sequentially.

Data such as latitude, longitude, elevation-value, and the like of the base map (5 m-DEM (A)) (hereinafter collectively referred to as a 5 m-DEM point Mpij) is assigned to four corners of the super-resolution square meshes Mbi. A top-right corner will be described as a representative value (which may be a center of the mesh).

For each super-resolution square mesh Mbi, the elevation-value, latitude, and longitude of the super-resolution fine mesh mbi (hereinafter referred to as a super-resolution fine mesh point Pij) is determined and assigned by bilinear interpolation (also called interpolation) using the 5 m-DEM point Mpij with respect to the super-resolution fine mesh mbi of each super-resolution square mesh Mbi. The elevation-value is referred to as an interpolated elevation-value zri.

A raster coloring process of coloring the super-resolution fine meshes mbi based on the interpolated elevation-value zri is performed (S40). In the present embodiment, an image created by coloring the super-resolution fine meshes mbi is also referred to as a fine raster image mgi.

For each super-resolution fine mesh mbi (fine raster image mgi), a moving-average with respect to the interpolated elevation-value zri (zr1, zr2, . . . ) of the super-resolution fine mesh point Pij is performed (S50).

The moving-average is performed by applying a moving-average mesh Fmi (also referred to as a moving-average filter) defined by the division point number DKi (3×3, 5×5, 7×7, or 9×9) (Box Average).

The interpolated elevation-value zri of the super-resolution fine mesh point Pij of the super-resolution fine mesh mbi (fine raster image mgi), which designates the elevation-value after the moving-average as a smoothing elevation-value zhi, is updated to the smoothing elevation-value zhi (referred to as a super-resolution smoothing process).

When a moving-average process is performed with respect to all super-resolution fine meshes mbi (fine raster images mgi) in the area Ei, the sets are displayed on a screen as moving-average fine raster images GHi (S60). Details will be provided later.

Then, an operator determines whether or not the moving-average fine raster images GHi on the screen are smooth (whether or not gradation is appropriate), and when not smooth, inputs a command to perform the super-resolution smoothing process once again to cause processing of step S50 to be performed once again.

Alternatively, when determined to be smooth, a plane-rectangular coordinate conversion process and resampling are performed (S90), resampling and a super-resolution red stereoscopic image generation process are performed after adjusting the X-direction to make squares (S100), and the squares are displayed on the screen (S110).

In other words, as initial processing, a square 5 m-DEM mesh defined using latitude and longitude is defined as a fine (super-resolution) square mesh (super-resolution fine mesh) using the values of latitude and longitude without performing plane-rectangular coordinate conversion (for example, Mercator) and TIN (triangulated irregular network) bilinear interpolation and a moving-average process are performed, plane-rectangular projection conversion is then performed to adjust the X-direction, squaring and resampling is performed, and a red stereoscopic image generation process is performed.

In other words, since processing of converting a latitude/longitude coordinate into a plane-rectangular coordinate is not performed in an initial process, no errors occur. Therefore, time until a super-resolution image is obtained becomes shorter (processing speed is faster).

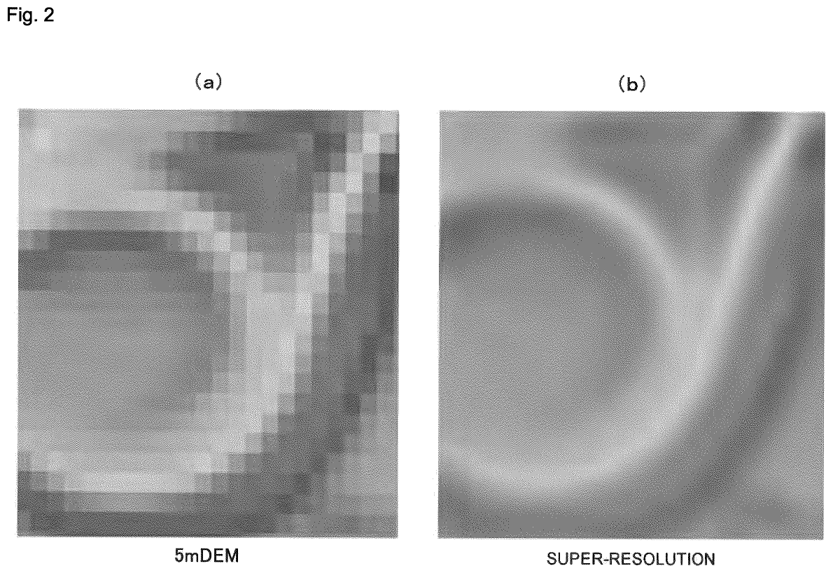

Accordingly, as illustrated in FIG. 2(a), while a cluster of fine meshes (mbi) are displayed jagged when enlarging an image of a 5 m-DEM after conventional processing, as illustrated in FIG. 2(b), an image that remains smooth even when enlarged is produced in the present embodiment. The super-resolution red stereoscopic image generation process will be described later.

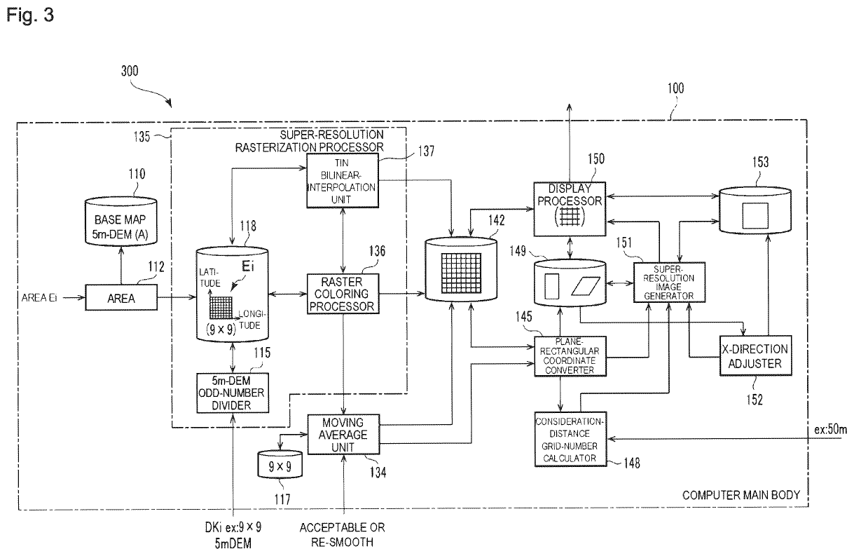

FIG. 3 is a program block diagram of the high-speed super-resolution image stereoscopic visualization processing system according to the first embodiment.

As illustrated in FIG. 3, the high-speed super-resolution image stereoscopic visualization processing system 300 according to the first embodiment includes a computer main body 100 and a display 200.

The computer main body 100 includes a base map database 110 storing the 5 m-DEM base map Fa, an area definition unit 112, a super-resolution rasterization processor 135, a moving-average unit 134, a consideration-distance grid-number calculator 148, a plane-rectangular coordinate converter 145, a super-resolution image generator 151, an X-direction adjuster 152, and a display processor 150.

The super-resolution rasterization processor 135 includes a 5 m-DEM odd-number divider 115, a TIN bilinear interpolation unit 137, and a raster coloring processor 136.

### (Description of System Components)

The area definition unit 112 reads a 5 m-DEM mesh Mai (latitude, longitude, elevation, 5 m frame) of a region corresponding to an area Ei (for example, 50 m to 1500 m in length and width) entered (designated) by the operator from a 5 m-DEM digital model of the base map database 110 to a memory 118.

The 5 m-DEM odd-number divider 115 of the super-resolution rasterization processor 135 divides an edge in a latitudinal direction (hereafter referred to as the latitudinal direction) and an edge in a longitudinal direction (hereafter referred to as a longitudinal direction) of the 5 m-DEM mesh Mai (Mai: 5 m or 10 m), which is a square mesh in the area Ei of the memory 118, into odd numbers (not including 1: 9×9) to sequentially generate a super-resolution square mesh Mbi having a cluster of square super-resolution fine meshes mbi.

The TIN bilinear interpolation unit 137 copies the square super-resolution square meshes Mbi to a memory 142.

In addition, for each of the super-resolution square meshes Mbi (latitude/longitude), TIN bilinear interpolation (interpolation process) is performed to assign an interpolated elevation-value zri to each super-resolution fine mesh mbi of the super-resolution square mesh Mbi.

The raster coloring processor 136 assigns a color value based on the interpolated elevation-value zri in the memory 142, causes the display processor 150 to be described later to display the color value on a screen, and starts up the moving-average unit 134.

The moving-average unit 134 applies, for each of the super-resolution square meshes Mbi in the memory 142, a moving-average process (using a 9×9 moving-average mesh) to each super-resolution fine mesh mbi a predetermined number of times, and updates the interpolated elevation-value zri with a smoothing elevation-value zhi.

The plane-rectangular coordinate converter 145 defines the super-resolution square mesh Mbi after moving-average in the memory 142 by plane-rectangular coordinates to generate a plane-rectangular super-resolution mesh Mdi in a memory 149.

While the plane-rectangular super-resolution mesh Mdi assumes a square, a rectangle, a trapezoid, or the like, a square will be mainly described in the present embodiment.

The X-direction adjuster 152 generates, in a memory 153, a square adjustment super-resolution mesh Mei (also referred to as square conversion super-resolution mesh) by adjusting the plane-rectangular super-resolution mesh Mdi (memory 149) to assume a square.

The super-resolution image generator 151 designates the square adjustment super-resolution mesh Mei (square conversion super-resolution mesh) in the memory 153 and, for every designation, sequentially designates an adjustment fine mesh mei of the square adjustment super-resolution mesh Mei as a subject point.

Then, a slope gradient with an adjustment fine mesh mei adjacent to the adjustment fine mesh mei designated as a subject point is determined based on the smoothing elevation-value zhi and assigned to the adjustment fine mesh mei of the subject point.

In addition, the number of super-resolution fine meshes from the consideration-distance grid-number calculator 148 (hereinafter referred to as a consideration-distance super-resolution fine mesh number) is read, a ridge-valley value (also referred to as an elevation-depression degree) between the adjustment fine mesh mei of the subject point and the adjustment fine mesh mei adjacent to the subject point in the consideration-distance super-resolution fine mesh number, and a gradation color value (reddish color) indicating a color value of a combination of the ridge-valley value and the slope gradient is assigned to the adjustment fine mesh mei of the subject point.

The pieces of data are stored in the memory 153. Specifically, the memory 153 stores a super-resolution DEM that is a set of super-resolution DEM data including the area Ei, the super-resolution square mesh Mbi, the super-resolution fine mesh mbi (number), the division width da, the bilinearly interpolated elevation-value zri, the smoothing elevation value zhi, the slope gradient of each super-resolution fine mesh mbi, the color value of the slope gradient, and the color value of the elevation-depression degree (over-ground openness, under-ground openness).

The consideration-distance grid-number calculator 148 converts an area within an entered consideration distance L (for example, 50 m) from the subject point into the number of super-resolution fine meshes. For example, super-resolution fine meshes corresponding to L/da is outputted to the super-resolution image generator 151.

The display processor 150 includes a display memory (not illustrated), reads data in accordance with an entered image type into the display memory, and displays images (super-resolution stereoscopic visualization images) of color values assigned to the data on a screen of the display.

Note that the super-resolution image generator 151 may assign a color value to the plane-rectangular super-resolution fine mesh mdi of the plane-rectangular super-resolution mesh Mdi in the memory 149 and cause the display processor 150 to display the plane-rectangular super-resolution fine mesh mdi to which the color value has been assigned as a super-resolution stereoscopic visualization image.

### (Description of Operations)

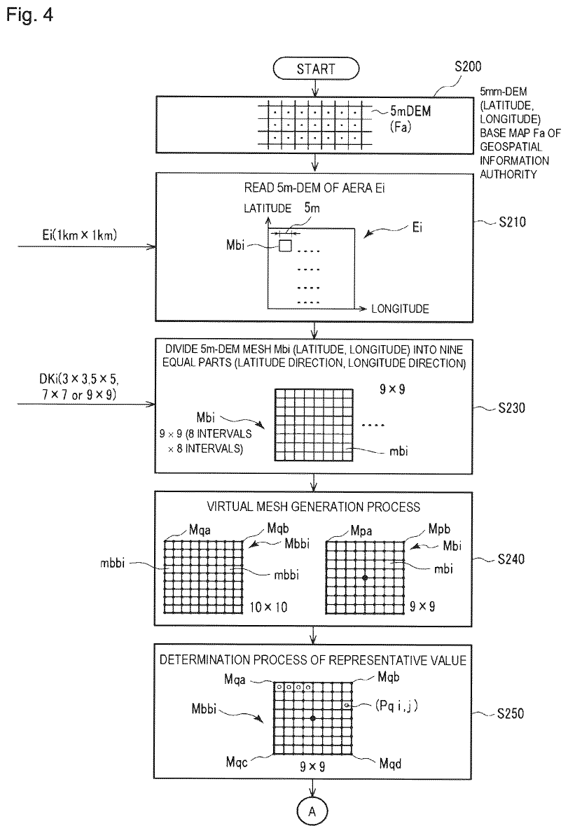

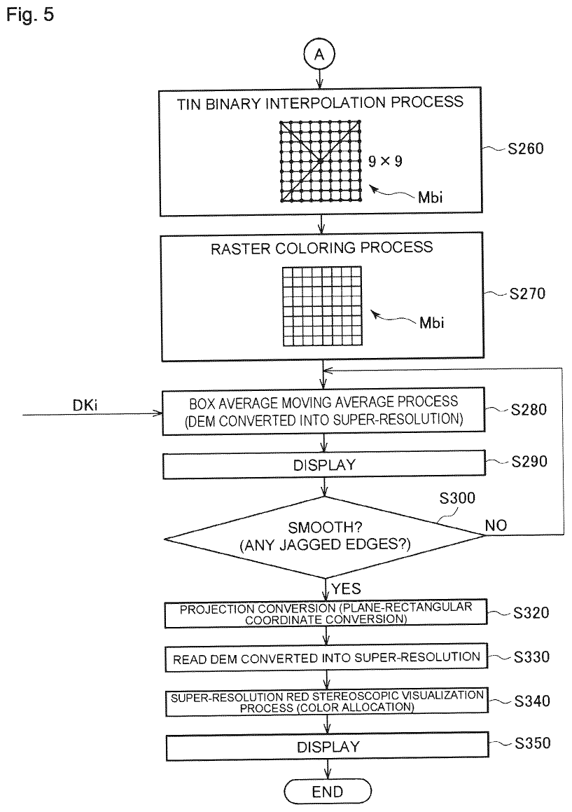

FIGS. 4 and 5 are detailed flowcharts of the high-speed super-resolution image stereoscopic visualization processing system according to the present first embodiment.

The base map database 110 stores a 5 m-DEM base map Fa (topography) (S200).

The 5 m-DEM of the 5 m-DEM base map Fa is provided with a cluster of measure points (intervals of tens of centimeters) acquired by airborne laser measurements, and the area of the measure points covers the whole of Japan (tens to hundreds of kilometers).

Each of the measure points includes a latitude, a longitude, an elevation-value, an intensity, and the like, and, in the present embodiment, simply referred to as 5 m-DEM points, quadruple corners of a 5 m-DEM frame are referred to as 5 m-DEM quadruple corner points Maq (q: a, b, c, d).

In addition, the 5 m-DEM quadruple corner points Maq (q: a, b, c, d), the 5 m-DEM point, and a mesh frame of 5 m will be collectively referred to as a 5 m-DEM mesh Mai (square) in the present embodiment.

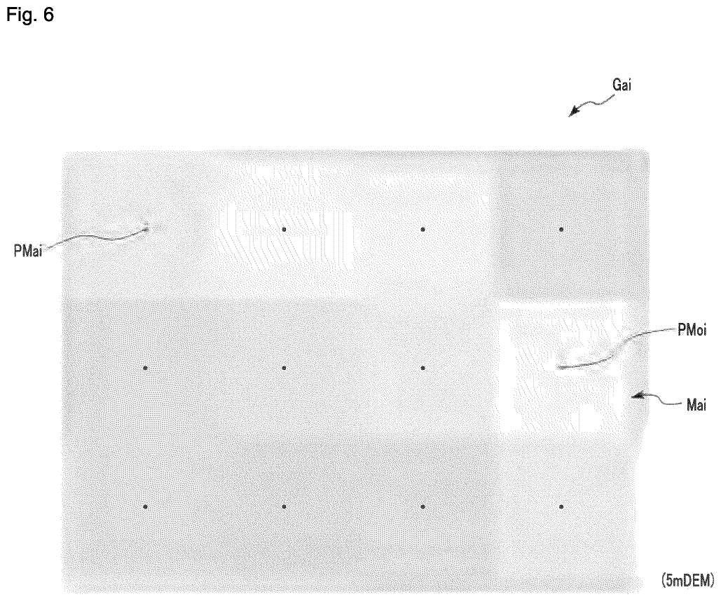

The area definition unit 112 designates a region corresponding to the area Ei (for example, 50 m to 1500 m, 2000 m, . . . , 5000 m, . . . , 10000 m, . . . in length and width) entered (designated) by the operator as the 5 m-DEM digital model of the base map database 110 and reads a 5 m-DEM mesh Mai (latitude, longitude, elevation, 5 m frame) of the designated area Ei into the memory 118 (S210: see FIG. 6).

However, FIG. 6 is an image displayed by a display processor 150 by coloring slope gradients. PMoi is an example of taking a representative value at a center of the 5 m-DEM mesh Mai.

In other words, the 5 m-DEM mesh Mai (latitude, longitude, elevation, frame) is defined in the memory 118. Note that an X axis is defined using longitude and a Y axis is defined using latitude in the memory 118.

Specifically, latitude and longitude are exported to an XY file. While the latitudinal direction is the Y direction and the longitudinal direction is the X direction, the directions will be simply referred to as the latitudinal direction and the longitudinal direction. In addition, in order to distinguish from plane-rectangular coordinates, drawings may feature “i” to indicate the latitudinal direction (Y direction) and “j” to indicate the longitudinal direction (X direction).

Next, the super-resolution rasterization processor 135 performs a fine rasterization process.

### (Super-Resolution Rasterization Processor 135)

The 5 m-DEM odd-number divider 115 of the super-resolution rasterization processor 135 sequentially generates, in the memory 118, the super-resolution square mesh Mbi divided by the division point number DKi (3×3, 5×5, 7×7, or 9×9) for obtaining a cluster of the super-resolution fine meshes mbi that divide the inside of the 5 m-DEM mesh Mai in the memory 118 based on the entered division point number DKi (3×3, 5×5, 7×7, or 9×9), a type of DEM (in the present embodiment, described as 5 m-DEM), and the like (S230).

However, FIG. 6 is an image (enlarged image) displayed by the display processor 150 by coloring slope gradients.

Note that in terms of the division width da, it is approximately 0.02 seconds in latitude and longitude (for example, equivalent to 0.55555 m in the case of 9×9).

In the present embodiment, the 5 m-DEM mesh Mai converted into super resolution is referred to as the super-resolution square mesh Mbi and a mesh in a da size is referred to as the super-resolution fine mesh mbi.

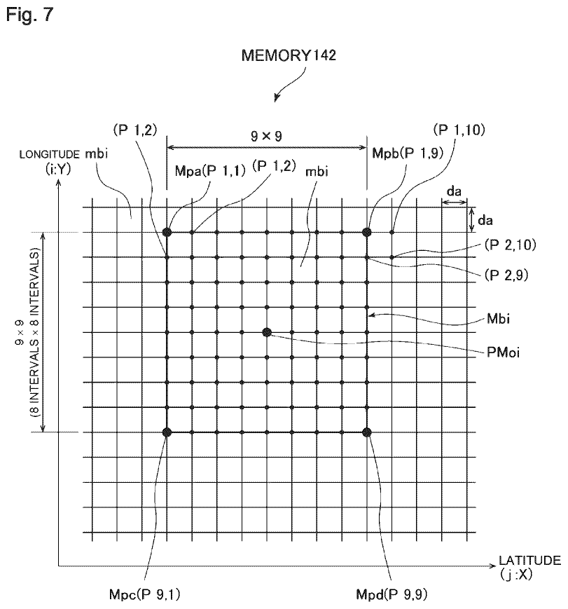

S230 in FIG. 4 and FIG. 7 illustrate the super-resolution square mesh Mbi.

In FIG. 7, points of four corners of the super-resolution square mesh Mbi are referred to as super-resolution square mesh corner representative points Mpq (Mpa, Mpb, Mpc, and Mpd).

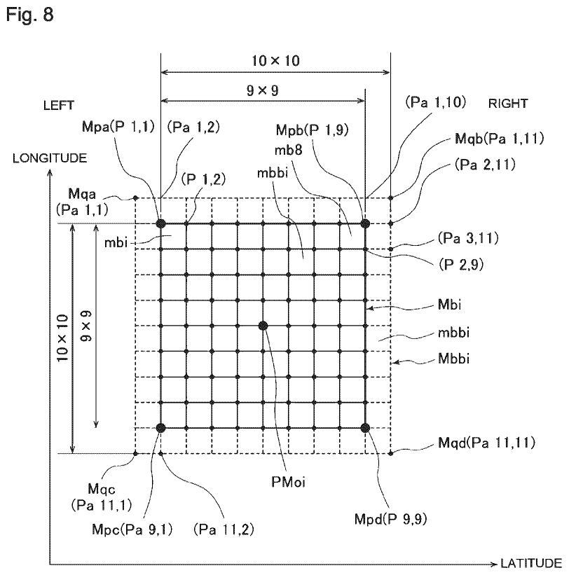

In addition, points such as latitude, longitude, elevation-value, and the like are assigned using a virtual super-resolution mesh to be described later to the four corners of each super-resolution fine mesh mbi (see FIG. 8).

In the present embodiment, these points are referred to as super-resolution fine mesh points Pij. In this case, “i” denotes the latitudinal direction (X direction) and “j” denotes the longitudinal direction (Y direction).

In FIG. 8, the super-resolution square mesh corner representative points Mpq (Mpa, Mpb, Mpc, and Mpd) are described as super-resolution fine mesh points Pij ((P1, 1), (P1, 9), (P9, 1), (P9, 9)) and the super-resolution fine mesh points Pij of the four corners defining the super-resolution fine mesh mbi adjacent to (P1, 9) are described as (P1, 9), (P2, 9), (P1, 10), and (P2, 10).

In other words, Mpa is (P1, 1), Mpb is (P1, 9), Mpc is (P9, 1), and Mpd is (P9, 9). Note that PMoi is an example where the center of the super-resolution square mesh Mbi is representative (elevation-value) (referred to as a super-resolution square mesh central representative point PMoi).

Then, processing (also referred to as a virtual 10×10 mesh generation process) is performed to virtually generate a cluster of 10×10 (size corresponds to 0.02 seconds) meshes (hereinafter referred to as virtual super-resolution meshes Mbbi) in a memory not illustrated (S240: see FIG. 8).

The virtual 10×10 mesh generation process will now be described.

Since the representative value (elevation) of the super-resolution square mesh Mbi is determined by averaging points of the four corners of the mesh, the representative value cannot be defined unless the points (elevations) of the four corners are known.

For this reason, the virtual 10×10 mesh generation process is performed.

The virtual 10×10 mesh generation process generates the virtual super-resolution meshes Mbbi (10×10 is division line number, the number of super-resolution fine meshes is 9×9) for each super-resolution square mesh Mbi (indicated by dotted lines).

In FIG. 8, the representative points of the four corners of the virtual super-resolution mesh Mbbi are described as Mqa, Mqb, Mqc, and Mqd. In addition, points of the virtual fine mesh mbbi of the virtual super-resolution mesh Mbbi are described as (Pa1, 1), (Pa1, 2), . . . , (Pa1, 11), . . . , (Pa11, 1), (Pa11, 2), . . . , (Pa11, 11). These (Pa1, 1), (Pa1, 2), . . . , (Pa1, 11), . . . , (Pa11, 1), (Pa11, 2), . . . , (Pa11, 11) will be collectively referred to as a virtual fine mesh point (Pai, j).

Then, super-resolution 5 m-DEM mesh representative value determination process is performed (S250). First, the super-resolution square mesh corner representative points Mpq (Mpa, Mpb, Mpc, and Mpd) of the four corners of the super-resolution square mesh Mbi are determined (calculated).

Specifically, for example, the super-resolution square mesh point Mpb (elevation) of the upper right corner of the super-resolution square mesh Mbi in FIG. 8 determines the super-resolution square mesh corner representative point Mpa based on the respective elevation-values of the virtual fine mesh points (Pa1, 10), (Pa1, 11) and (Pa2, 10) of mbb10 of the virtual super-resolution mesh Mbbi.

Then, the TIN bilinear-interpolation unit 137 performs a TIN bilinear interpolation process as illustrated in FIG. 5 (S260).

The TIN bilinear interpolation process (S260) copies the square super-resolution square meshes Mbi and related data in the memory 118 to the memory 142. Then, the super-resolution fine meshes mbi of the super-resolution square mesh Mbi are sequentially designated.

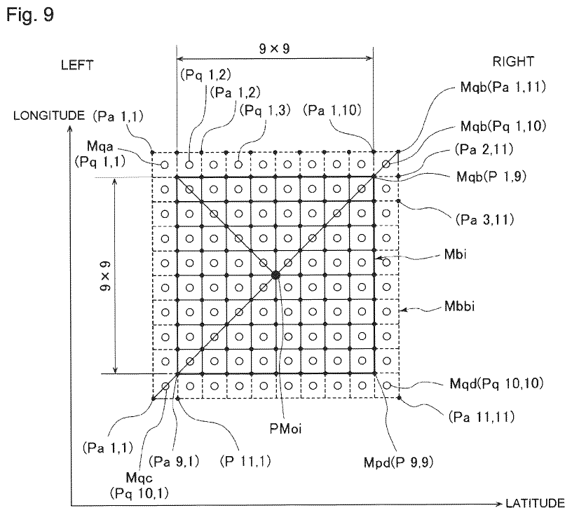

Then, the super-resolution fine mesh representative point Pqij (elevation) of the designated super-resolution fine mesh mbi is calculated by TIN bilinear interpolation (interpolation of elevation-value) based on the super-resolution square mesh corner representative point Mpq of the virtual super-resolution mesh Mbbi, the super-resolution fine mesh point Pij of the designated super-resolution fine mesh mbi of the super-resolution square mesh Mbi, the super-resolution square mesh central representative point PMoi, and the like (see FIG. 9).

FIG. 9 is an explanatory diagram of TIN bilinear interpolation.

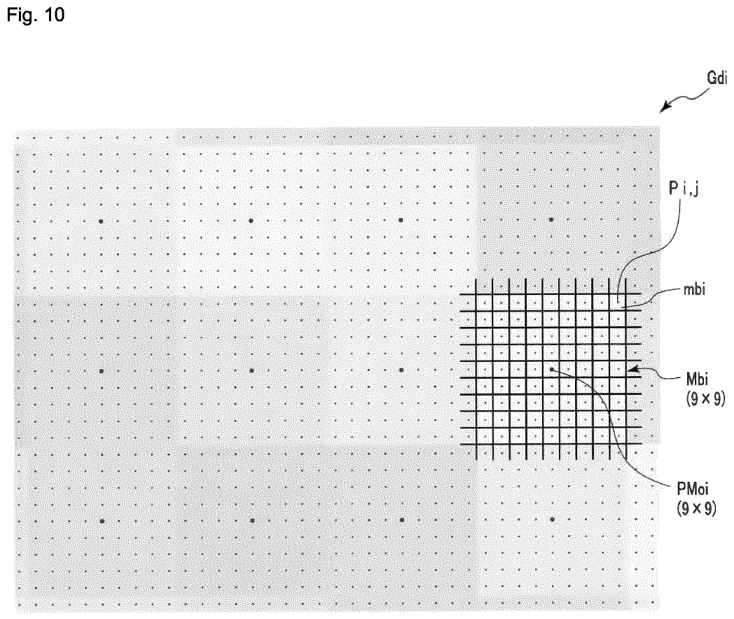

Note that FIG. 9 represents an example of adopting the center of the super-resolution fine mesh mbi as the super-resolution fine mesh representative point Pqij. In addition, FIG. 10 is an explanatory diagram of points when performing the TIN bilinear interpolation process.

FIG. 10 illustrates a situation of the super-resolution square mesh Mbi and the virtual super-resolution mesh Mbbi when performing the TIN bilinear interpolation process. However, elevations have been colored.

Note that an elevation-value after TIN bilinear interpolation of the super-resolution fine mesh representative point Pqij is referred to as a bilinearly interpolated elevation-value zri (zr1, zr2, . . . : also referred to as an interpolated elevation-value).

In FIG. 10, a frame of the super-resolution square mesh Mbi and a frame of mbi are described in a partial region (for example, 5 m×5 m).

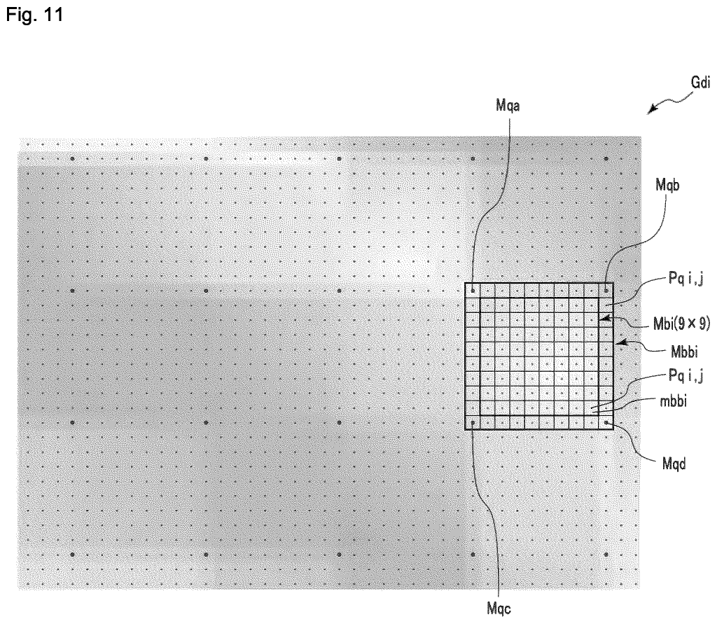

FIG. 11 is an example of an image of a result of bilinear interpolation. Compared to FIG. 10, colors (the darker the color, the darker the vermilion) are more dispersed as a whole.

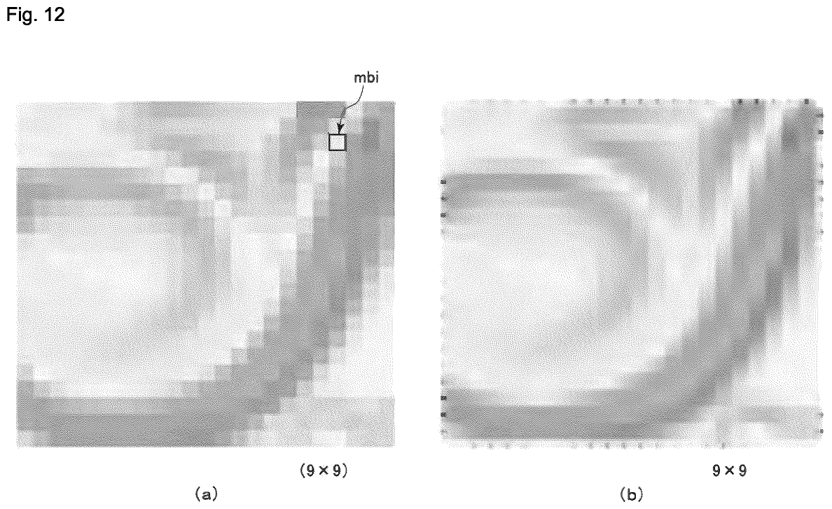

FIG. 12 is an enlarged view explaining before bilinear interpolation and after bilinear interpolation. FIG. 12(a) represents before bilinear interpolation and FIG. 12(b) represents after bilinear interpolation, both displaying colored elevation. While mbi is jagged as illustrated in FIG. 12(a), colors are dispersed as a whole as illustrated in FIG. 12(b).

Then, the TIN bilinear interpolation unit 137 starts a raster coloring processor 136 when the bilinear interpolation process has been performed for all super-resolution fine meshes mbi in all super-resolution square meshes Mbi in the memory 142.

The rasterization coloring processor 136 sequentially designates the super-resolution fine meshes mbi in the memory 142, reads the bilinearly interpolated elevation-value zri (zr1, zr2, . . . ) for each designation, and assigns a color value in accordance with the elevation-value to the super-resolution fine mesh mbi (S270).

However, the super-resolution fine mesh mbi is jagged due to being a fine mesh and results in an image containing so-called noise. Therefore, a moving-average process (for example, Kalman filtering) is performed in order to increase correlation between respective data points to make pieces of data connect to each other in a smoother manner and to remove effects of uncorrelated singularities and noise (S280).

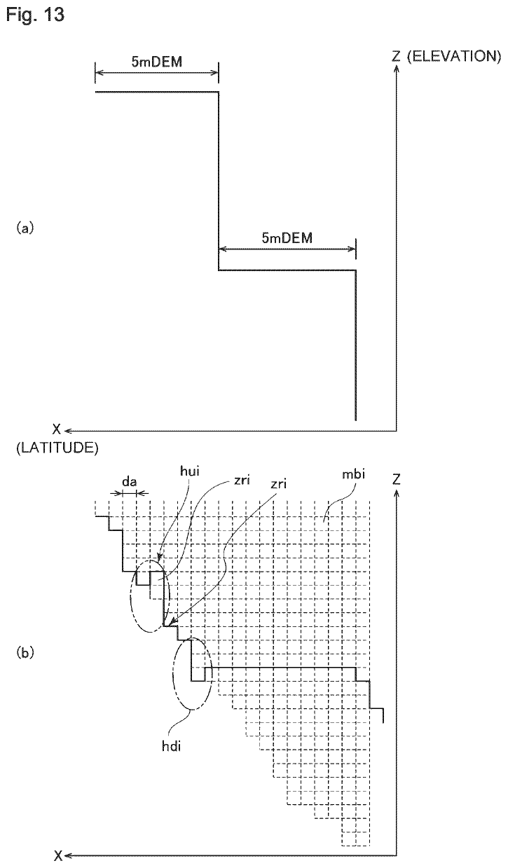

For example, when subjecting the 5 m-DEM illustrated in FIG. 13(a) to bilinear interpolation, as illustrated in FIG. 13(b), the bilinearly interpolated elevation-value zri is sharply protruded (hui portion), or in valleys, the value drops sharply (hdi portion).

### (Moving-Average)

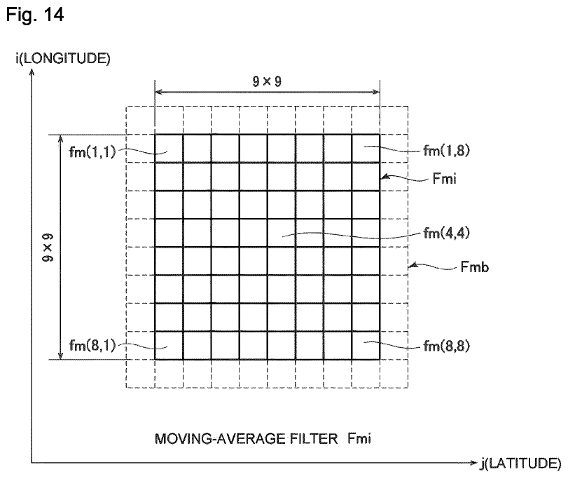

The moving-average unit 134 generates a moving-average mesh Fmi (see FIG. 14) in a memory 117 for the division point number DKi (for example, 3×3, 5×5, 7×7 or 9×9) entered by the operator. In the present first embodiment, the division point number DKi is described as being 9×9.

Note that FIG. 14 describes mesh numbers fm (i,j) with “i: latitude” as the vertical row and “j: longitude” as the horizontal column of the moving-average mesh Fmi.

As illustrated in FIG. 14(b), the division point number DKi of the moving-average mesh Fmi (also referred to as a filter) may be 11×11 (a size of one mesh corresponds to 0.02 seconds) (described as Fmb: dotted lines).

Note that a moving-average value (weighted average) in a central mesh is referred to as a smoothing elevation-value zfi (also referred to as a smoothing elevation value) (also referred to as a moving-average elevation-value zfi), and the value of the designated super-resolution fine mesh mbi is updated to the smoothing elevation-value zfi.

The raster coloring processor 136 is started to assign a color (according to the color scale) in accordance with the smoothing elevation-value zfi in the memory 142 to the super-resolution fine mesh mbi in the memory 142 and cause the display processor 150 to display the color on the screen of the display 200 (S290).

In the present embodiment, the image displayed on the screen is referred to as a super-resolution image GZi.

Then, the operator determines whether or not the super-resolution image GZi on the screen is a desired smooth image (S300).

When the image is not smooth, a super-resolution smoothing process instruction is entered once again and the moving-average unit 134 causes processing of step S280 once again to be performed based on the re-smoothing instruction.

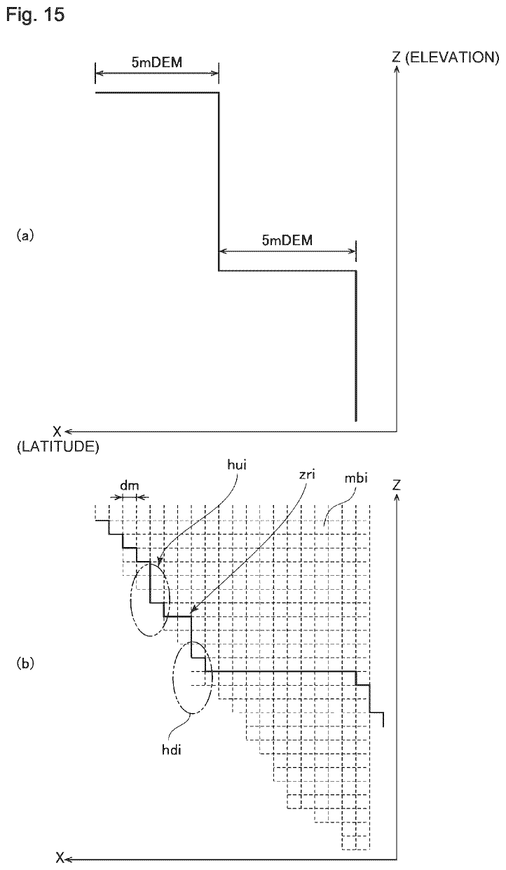

Due to the moving-average process, as illustrated in FIG. 15(b), a portion where the bilinearly interpolated elevation-value zri is sharply protruded (hui portion) disappears and a portion in the valley where the value drops sharply (hdi portion) disappears. In other words, the image becomes smoother.

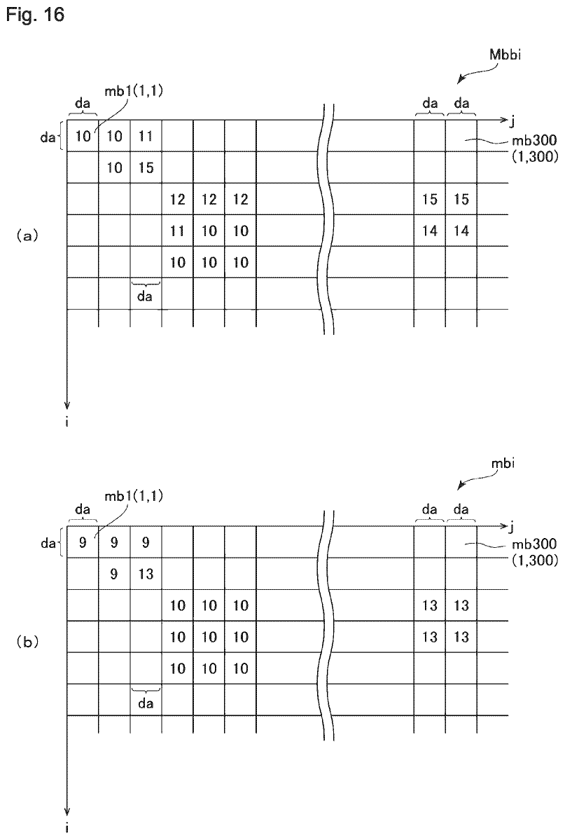

Specifically, the bilinearly interpolated elevation-values zri in FIG. 16(a) (for example, 10, 10, 11, . . . 15, 12, 12, 12, 11, . . . 10 become 9, 9, 9, . . . 1320, 10, 10, 10, . . . 10 as illustrated in FIG. 16(b).

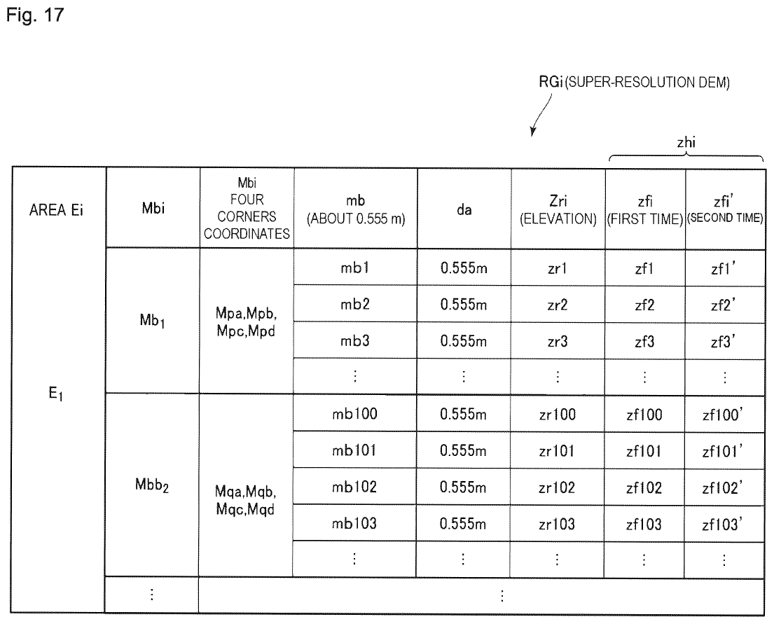

In other words, the memory 142 stores super-resolution smoothing DEM data RGi that is the original data for the super-resolution image GZi illustrated in FIG. 17.

As illustrated in FIG. 17, the super-resolution smoothing DEM data RGi includes the area Ei, the super-resolution square mesh Mbi, the super-resolution fine mesh mbi (number), the division width (for example, a curved surface width corresponding to 0.555 m), the bilinearly interpolated elevation-value zri, a first smoothing fine elevation-value zfi, and a second smoothing fine elevation-value zfi′.

Note that the smoothing fine elevation-value zfi and the second smoothing fine elevation-value zfi′ are also collectively referred to as smoothing values.

In addition, in the present embodiment, zri, zfi, zfi′, . . . are collectively referred to as smoothing elevation-values zhi.

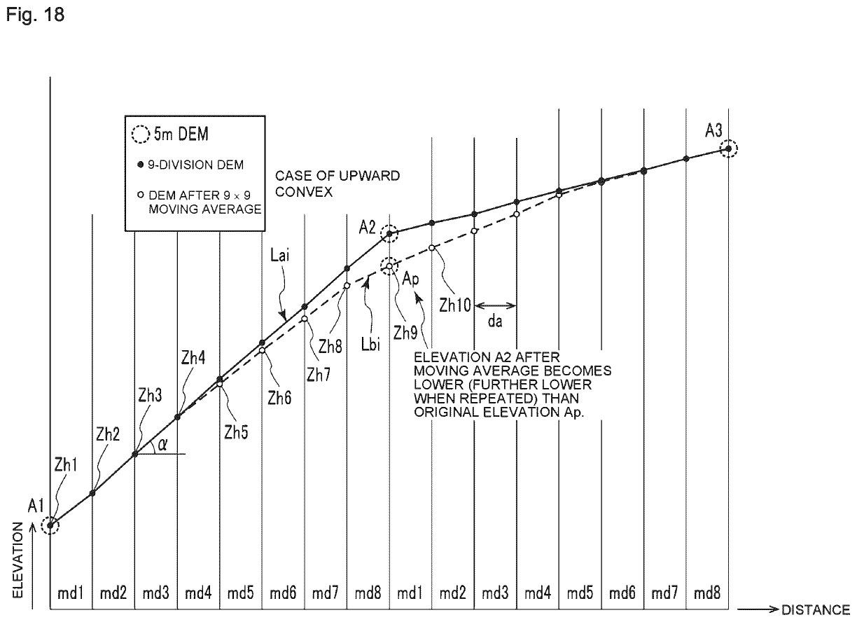

A trajectory of elevation when not performing the super-resolution image smoothing process (moving-average) is illustrated in FIG. 18.

As illustrated in FIG. 18, since a curvature maximization process (spline curve, Bezier curve, or the like) is to be performed when no moving-average is performed, for example, a trajectory connecting point A1, vertex A2, and point A3 becomes a straight line Lai (depicted by a solid line), but since a moving-average process is performed in the present embodiment, the line connecting the smoothing elevation-values zhi (Lbi) will be an Ap point that does not pass through vertex A2 (it will be even lower if the moving-average is repeated).

Note that in FIG. 18, intervals between A1 and A2 and between A2 and A3 are described as widths of 5 m-DEM. In addition, the super-resolution fine mesh mbi is described from A1 as mb1, mb2, . . . , mb8, . . . , mb16.

In addition, when the image is determined to be a smooth image, the fact that the smooth image (super-resolution smoothing process: moving-average fine raster image GHi) is “OK” is entered.

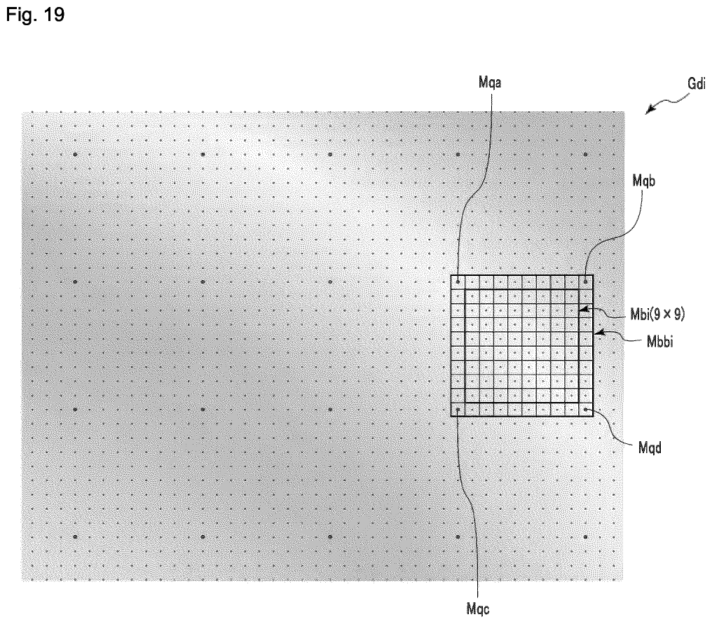

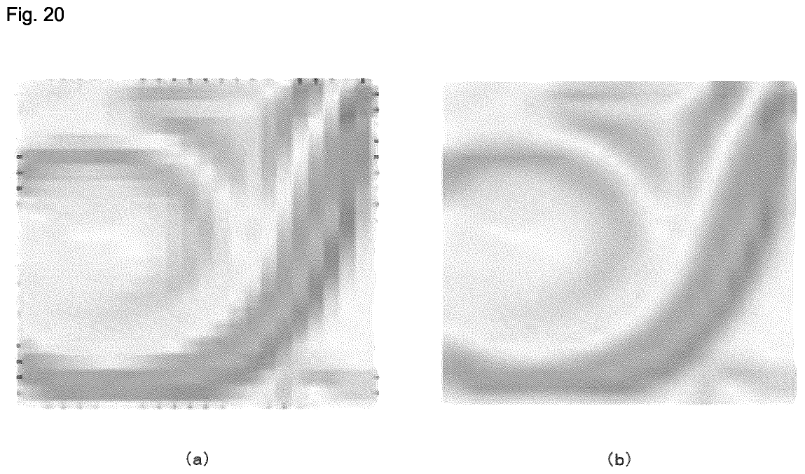

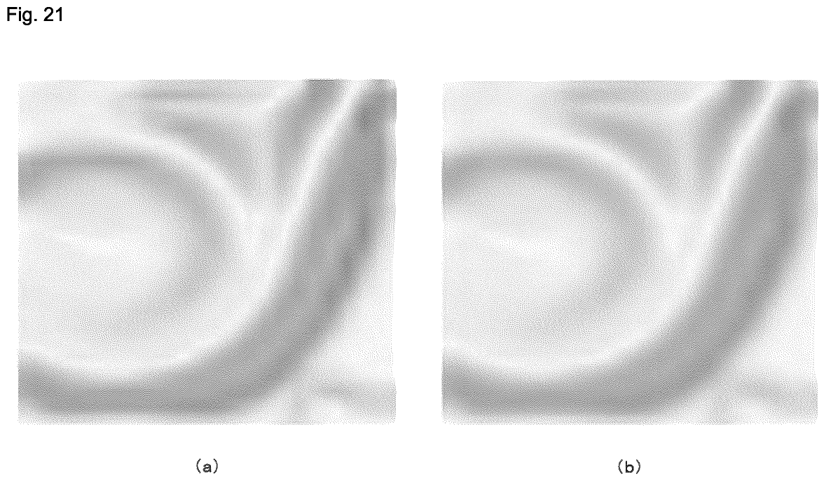

FIG. 19 illustrates an example (enlarged) of imaging the smoothing process (also referred to as a 9×9 box average process). FIG. 19 is illustrated in colors according to slope gradients. FIG. 20 is an enlarged view explaining an effect of a first moving-average, and FIG. 21 is an enlarged view explaining an effect of a second moving-average.

As illustrated in FIG. 20(a), while the image is jagged before the moving-average, after the first moving-average, the image changes to a smooth image in which jaggedness is suppressed as illustrated in FIG. 20(b).

Furthermore, in the second moving-average, the image after the first moving-average (FIG. 21(a)) has become smoother.

Then, when the smooth image (super-resolution smoothing process) is “OK” (operator's determination), the moving-average unit 134 starts the plane-rectangular coordinate conversion process and, next, the plane-rectangular coordinate converter 145 performs a projection conversion process (plane-rectangular coordinate conversion) (S320).

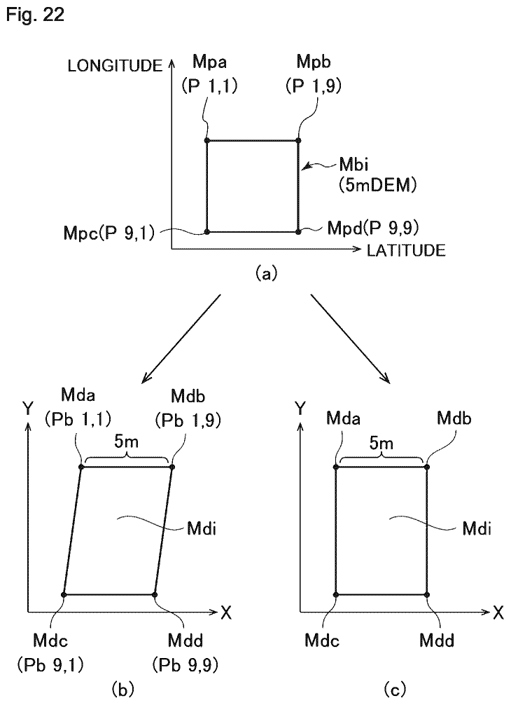

The projection conversion process (S320) converts the super-resolution fine mesh points Pij assigned to the super-resolution fine mesh mbi of the super-resolution square mesh Mbi (latitude and longitude) in the memory 142 into plane-rectangular coordinates and exports the converted super-resolution fine mesh points Pij to a plane-rectangular XYZ point file as plane-rectangular points Pbij (store in memory 149: see FIG. 22).

The projection conversion process will be described in detail later.

The plane-rectangular coordinate conversion is “equirectangular projection” generated by placing the earth inside a cylinder where only the equator of the earth comes into contact, projecting the lines of latitude and longitude onto the cylinder and then opening the cylinder, and the closer to the poles, the wider the intervals of the lines of latitude.

Therefore, when converted to plane-rectangular coordinates, the presence of distortion results in a skewed rectangle or a rectangle (sometimes a square) with no distortion, depending on the location.

In other words, the square super-resolution square mesh Mbi (latitude/longitude coordinates) illustrated in FIG. 22(a) becomes the plane-rectangular super-resolution mesh Mdi illustrated in FIG. 22(b) or FIG. 22(c).

The plane-rectangular super-resolution meshes Mdi are constituted of plane-rectangular points Pbij of (P1, 1), . . . , (Pb9, 9) and shapes of the meshes are mostly trapezoids or rectangle (also squares depending on the location). Note that the super-resolution fine mesh of the plane-rectangular super-resolution meshes Mdi is referred to as a plane-rectangular super-resolution fine mesh mdi.

A specific example is as follows. Idx, X, Y, Elevation (m), Length, Total Length, Heading 1, −10835.893, −32871.056, 41.274, 0.555 m, - - - , 269° 55′ 48.4″ 2, −10836.452, −32871.056, 41.412, 0.79 m, 0.555 m, 134° 52′ 44.3″ 320835.893, −32871.614, 41.214, - - - , 1.349 m, - - -

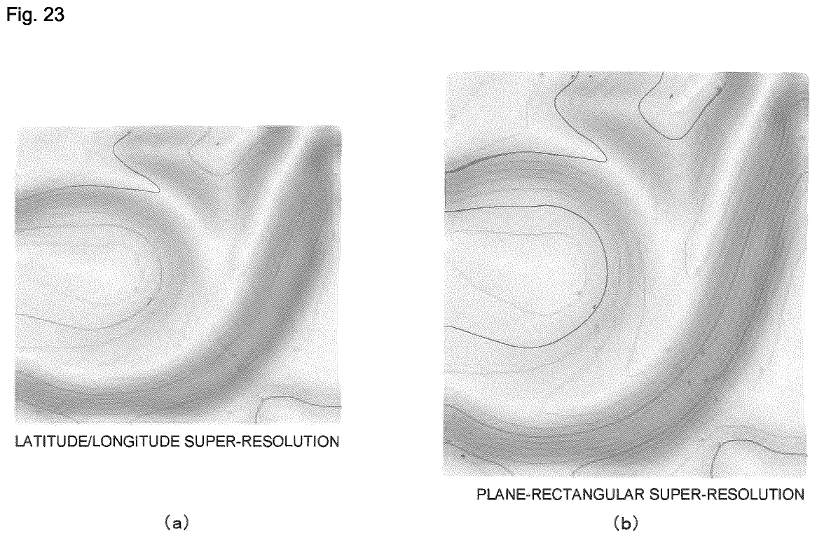

The description will be supplemented with reference to FIG. 23. FIG. 23(a) illustrates an image before plane-rectangular coordinate conversion (also referred to as projection conversion) and FIG. 23(b) illustrates an image after projection conversion. However, FIGS. 23(a) and 23(b) illustrate examples in which colors are applied to elevation-values. As illustrated in FIG. 23(b), the image in FIG. 23(a) is stretched.

Next, the super-resolution image generator 151 reads the plane-rectangular super-resolution fine mesh mdi of the plane-rectangular super-resolution mesh Mdi in the memory 149 (S330), performs the super-resolution image stereo processing (S340), reads the image into the display memory and displays the image on the screen of the display 200 (S350).

Although not illustrated in the flowchart, the X-direction adjuster 152 performs an X-direction adjustment process before the super-resolution image stereoscopic visualization process (S340) described earlier is performed.

### (X-Direction Adjustment Process)

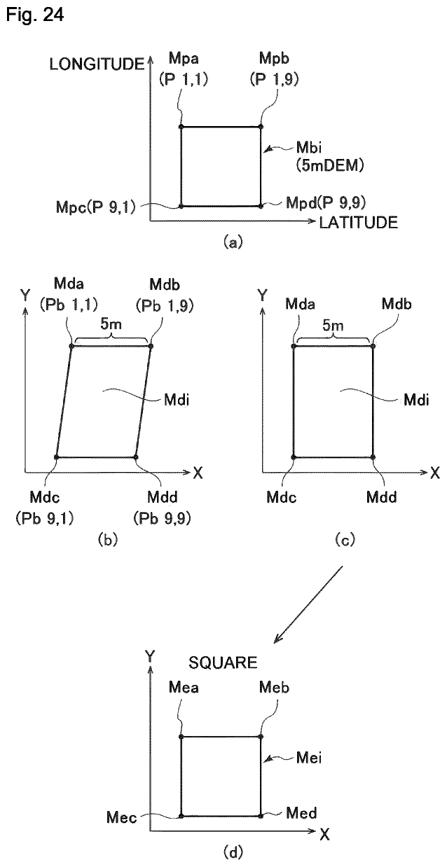

The X-direction adjuster 152 generates, in the memory 153, the square adjustment super-resolution mesh Mei by adjusting the plane-rectangular super-resolution mesh Mdi (for example, a rectangle or a trapezoid) in the memory 149 to assume a square (see FIG. 24). A square is assumed as illustrated in FIG. 24(d).

In other words, widths are adjusted so that the plane-rectangular super-resolution mesh Mdi becomes a square. This is referred to as the square adjustment super-resolution mesh Mei.

Specifically, the width in the Y-direction (edge) of the square adjustment super-resolution mesh Mei in the memory 149 is adjusted to be the same as the width in the X-direction (edge). In other words, the X direction (edge) of the plane-rectangular super-resolution mesh Mdi is moved upward (+ direction) so that the Y direction (edge in the longitudinal direction) of the plane-rectangular super-resolution mesh Mdi equals the width of the X direction (edge in the latitudinal direction) of the plane-rectangular super-resolution mesh Mdi. This is referred to as an adjustment in the X direction.

In addition, due to the adjustment, the X direction (edge in the latitudinal direction) of the plane-rectangular super-resolution fine mesh mdi is moved upward (+) so that the Y direction (longitude) of the plane-rectangular super-resolution fine mesh mdi equals the X direction (edge in the latitudinal direction) of the plane-rectangular super-resolution fine mesh mdi. In other words, the plane-rectangular super-resolution fine mesh mdi becomes a square. This is referred to as the adjustment fine mesh mei.

In other words, resampling is performed by subjecting data (elevation) of the plane-rectangular super-resolution fine mesh DEM of the square adjustment super-resolution mesh Mei to a projection conversion process (S320) onto a plane-rectangular coordinate system that matches the width of the planar rectangular super-resolution fine mesh mdi in the Y-direction (j: longitude) to the point spacing (0.5555 m: about 60 cm) in the X-direction (i: latitudinal direction) of the planar rectangular super-resolution fine mesh mdi of the plane-rectangular super-resolution mesh Mdi (for example, a rectangle or a trapezoid).

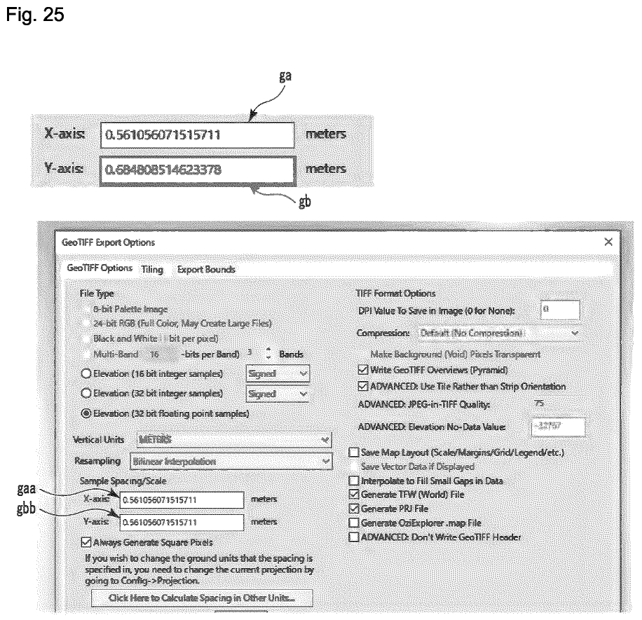

Specifically, adjustment is performed by displaying a screen such as that illustrated in FIG. 25. When ga (X-axis: 0.561056071515711) and gb (Y-axis: 0.684808514623378) are input, the computer's X-direction adjustment process produces gaa (X-axis: 0.561056071515711) and gbb (Y-axis: 0.561056071515711) on the screen below.

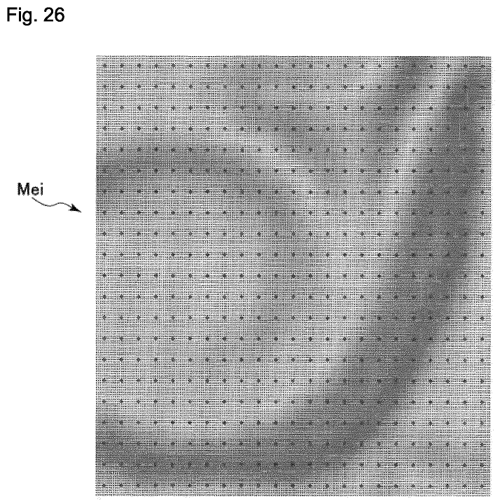

In other words, a square is produced. As illustrated in FIG. 26, the square adjustment super-resolution mesh Mei is formed by four large red circles, and the adjustment fine mesh mei is a square that is formed by four small red circles (Pai, j).

The fine mesh of the square adjustment super-resolution mesh Mei is referred to as the adjustment fine mesh mei.

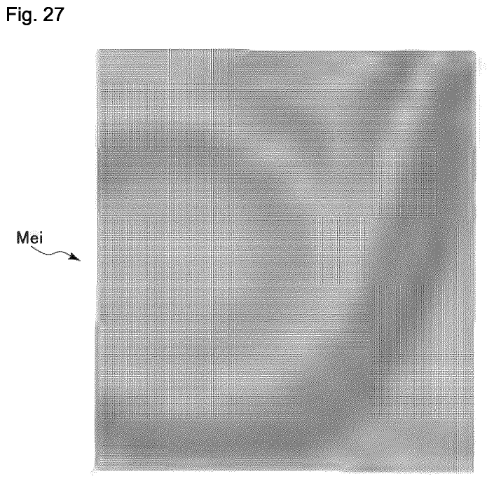

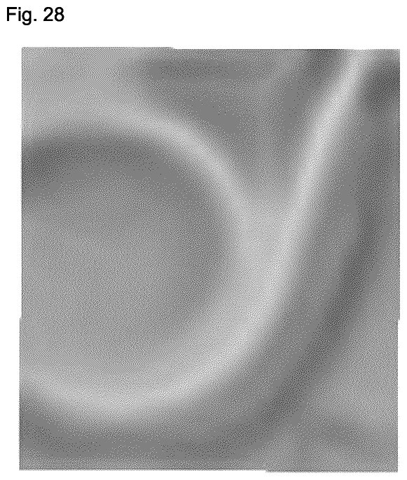

An effect of an image generated by the super-resolution image generator 151 to be described later using the square adjustment super-resolution mesh Mei will be described with reference to FIGS. 27 and 28.

As illustrated in FIG. 27, the large circles (large red circles) in FIG. 26 are removed (are not displayed). FIG. 28 represents an image by the super-resolution image generator 151 and is an image without jaggies and jaggedness.

In other words, the memory 153 stores, as super-resolution DEM preliminary data RMi (not illustrated), the area Ei (number), the square adjustment super-resolution mesh Mei number (Me1, Me2, . . . ), and for each square adjustment super-resolution mesh Mei, the adjustment fine mesh mei number (me1, me2, . . . ) constituting the square adjustment super-resolution mesh Mei, and the smoothing elevation-value and the like of each adjustment fine mesh mei.

In addition, before performing the super-resolution image stereoscopic visualization process (S340), the plane-rectangular coordinate converter 145 starts the consideration-distance grid-number calculator 148. The consideration distance L is necessary for performing the super-resolution image stereoscopic visualization process. Although not illustrated in the flowchart, the calculation of the consideration distance is performed by the consideration-distance grid-number calculator 148.

The consideration distance L outputs, to the super-resolution image generator 151 as a consideration distance-equivalent super-resolution fine mesh number KLi, the number of meshes corresponding to a case where the input consideration distance is 50 m and the division point number DKi is 9×9.

A slope gradient calculation process in the super-resolution image stereoscopic visualization process (S340) by the super-resolution image generator 151 will be described.

The slope gradient calculation process designates super-resolution DEM preliminary data RMi (area Ei, square adjustment super-resolution mesh Mei, adjustment fine mesh mei, smoothing elevation-value, and the like) in the memory 153.

Then, the square adjustment super-resolution mesh Mei included in the super-resolution DEM preliminary data RMi is designated and the adjustment fine mesh mei associated with the designated square adjustment super-resolution mesh Mei is designated.

Then, super-resolution DEM preliminary data RMi with adjustment fine meshes mei adjacent (for example, in four directions) to the designated adjustment fine mesh mei is designated.

Next, slope gradients between the smoothing elevation-values zhi of the adjustment fine meshes mei included in the designated super-resolution DEM preliminary data RMi and the smoothing elevation-value zhi of each adjustment fine mesh mei included in each piece of super-resolution DEM preliminary data RMi adjacent in the four directions are determined, and an average slope gradient (hereinafter, referred to as a slope gradient αi (or inclination)) of the slope gradients is associated with the designated adjustment fine mesh mei.

In other words, the average slope gradient is associated with the designated super-resolution DEM preliminary data RMi.

This process is performed for each of all adjustment fine meshes mei.

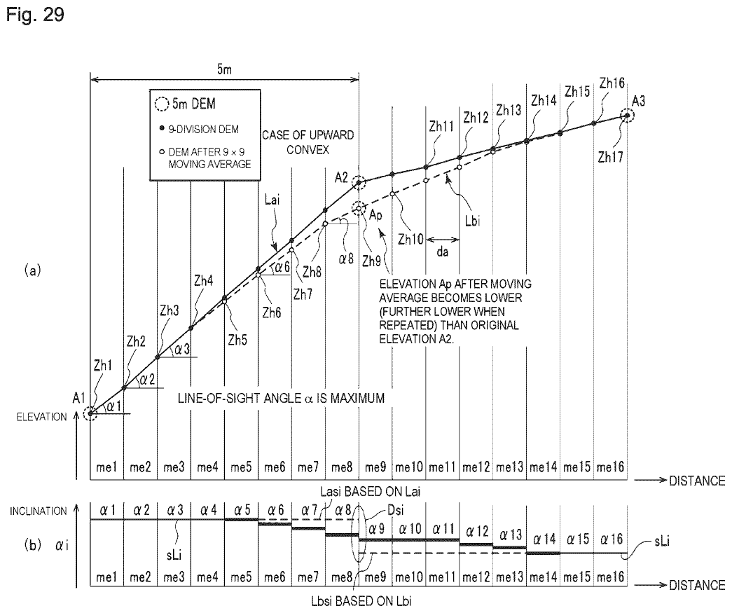

Mapping the slope gradient αi (α1, α2, . . . ) to a distance axis produces a result illustrated in FIG. 29(b).

In describing FIG. 29(b), FIG. 18 is described as FIG. 29(a).

A solid line in FIG. 29(b) is referred to as an averaging slope gradient plot line SLi (solid line).

As illustrated in FIG. 29(a), the smoothing elevation-value zhi of the adjustment fine meshes me1, me2, me3, and me4 between A1 and A2 increases at an approximately constant rate from zh1 to zh5.

Therefore, as illustrated in FIG. 29(b), there is no change to average slope gradients a1, a2, a3, and a4 of me1, me2, me3, and me4 between A1 and A2.

However, as illustrated in FIG. 29(a), heights of me5, me6, me7, and me8 between A1 and A2 gradually increase from zh5 to zh9.

Therefore, as illustrated in FIG. 29(b), average slope gradients α5, α6, α7, and α8 of me5, me6, me7, and me8 gradually decrease.

In addition, as illustrated in FIG. 29(a), heights of me9, me10, me11, and me13 between A2 and A3 smoothly increase from zh9 to zh14.

Therefore, as illustrated in FIG. 29(b), average slope gradients α9, . . . , α13 of me9, me10, me11, and me13 are also trending slightly downward.

The important point here is that, as illustrated in FIG. 29(b), plotting the slope gradient of Lai when moving-average (super-resolution smoothing process) is not performed to FIG. 29(b) results in a dotted line Lsai between A1 and A2 (me1 to me8) (covered by a solid line between me1 and me5).

In addition, between A2 and A3 (me9 and me16), an abrupt downward change occurs and results in a dotted line Lsbi (covered by a solid line between me14 and me16). The change location is described as Dsi.

However, in the present embodiment, because moving-average (super-resolution smoothing process) is performed, the Dsi location does not change abruptly and resembles the average slope gradient plot line SLi (solid line). Therefore, no jaggies occur.

Next, the super-resolution stereoscopic visualization process (S340) of the super-resolution image generator 151 sequentially designates the super-resolution DEM preliminary data RMi in the memory, and for each designated super-resolution DEM preliminary data RMi, the adjustment fine mesh mei contained in the super-resolution DEM preliminary data RMi is sequentially designated as the subject point.

For each of the subject points, the adjustment fine mesh mei corresponding to the consideration distance-equivalent super-resolution fine mesh number KLi is designated, and the adjusted fine mesh mei with the largest smoothing elevation-value zhi that exists among the designated adjustment fine meshes mei is retrieved.

In addition, using the adjustment fine mesh mei with the retrieved largest smoothing elevation-value zhi and the adjustment fine mesh mei of the subject point, an over-ground openness and an under-ground openness are determined to determine a ridge-valley value (also referred to as an elevation-depression degree).

Then, a gradation color value (reddish color) indicating a color value of a combination of the ridge-valley value and the slope gradient is assigned to the adjustment fine mesh mei of the subject point and imaged. This is referred to as a super-resolution reddened image (super-resolution stereoscopic visualization image Ki) in the present embodiment.

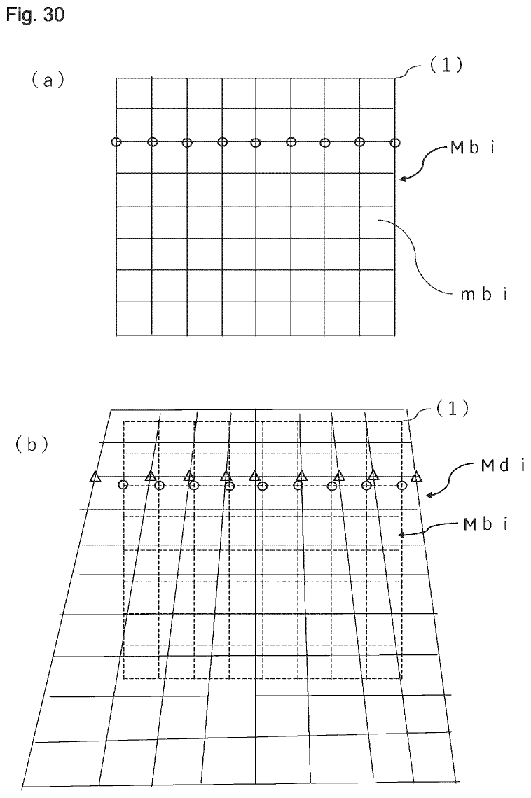

Resampling in the projection conversion process (S320) of the plane-rectangular coordinate converter 145 will now be described with reference to FIGS. 30, 31, and 32.

FIG. 30(a) illustrates the super-resolution square mesh Mbi (9×9: number of lines) after moving-average of the memory 142. An axis of ordinate represents longitude and an axis of abscissa represents latitude.

In addition, FIG. 30(a) illustrates a representative point (circle mark) at corners of mbi of the super-resolution square mesh Mbi (9×9) after moving-average. In FIG. 30(a), as an example, a circle marks a third lateral line from top of the super-resolution square mesh Mbi after moving-average.

Note that in FIG. 30(a), the axis of ordinate represents the latitudinal direction and the axis of abscissa represents the longitudinal direction.

FIG. 30(b) illustrates the plane-rectangular super-resolution mesh Mdi (solid line) after converting the super-resolution square mesh Mbi (before plane-rectangular conversion: 9×9) after moving-average into plane-rectangular coordinates.

In the plane-rectangular super-resolution mesh Mdi (solid line) after conversion into plane-rectangular coordinates, an axis of ordinate is represented by Y and an axis of abscissa is represented by X (Z-direction is not described).

Note that FIG. 30(b) illustrates a case where the plane-rectangular super-resolution mesh Mdi assumes a trapezoidal shape when converted into plane-rectangular coordinates.

In addition, in FIG. 30(b), the super-resolution square mesh Mbi after moving-average illustrated in FIG. 30(a) is illustrated superimposed (dotted line). A triangle mark illustrated in FIG. 30(b) is a resampling point of the representative point (circle mark) of the corner of mbi (however, this is an example where x and y are coincident). As an example, a triangle marks third lateral line from top of the plane-rectangular super-resolution mesh Mdi converted into plane-rectangular coordinates.

As illustrated in FIG. 30(b), the circle marks and the triangle marks are out of alignment.

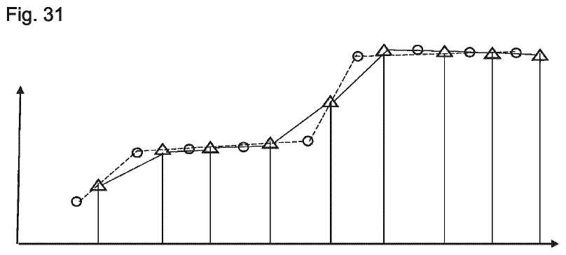

FIG. 31 is an explanatory diagram of a case where the Z direction (elevation) of FIG. 30(b) is taken as an axis of ordinate and the X direction is taken as an axis of abscissa. In other words, as illustrated in FIG. 31, a line (solid line) connecting the triangle marks depict a trajectory of elevations.

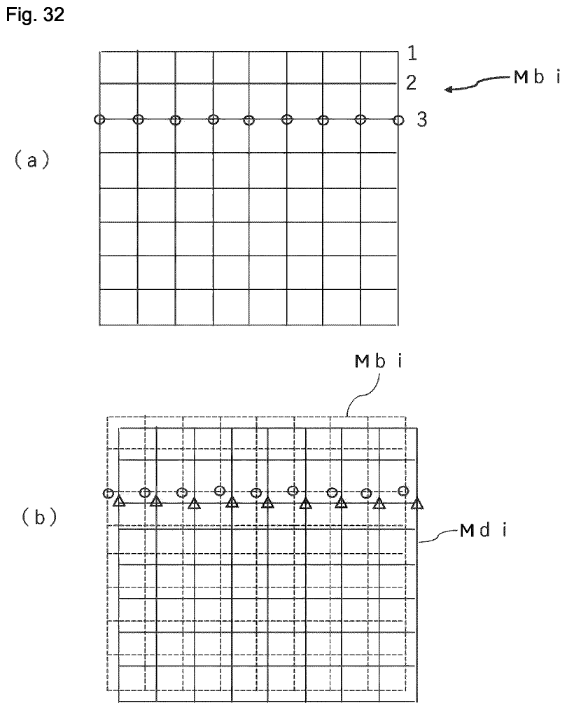

Note that FIG. 32 illustrates a case where the plane-rectangular super-resolution mesh Mdi assumes a rectangular shape when converted into plane-rectangular coordinates. FIG. 32(a) illustrates the super-resolution square mesh Mbi after moving-average but before plane-rectangular conversion. In FIG. 32(b), the super-resolution square mesh Mbi after moving-average illustrated in FIG. 32(a) is illustrated superimposed (dotted line).

The super-resolution image stereoscopic visualization process (S340) and the calculation of a consideration distance described above are performed using such data.

The super-resolution image stereoscopic visualization process (S340) described earlier uses the techniques described in Japanese Patent No. 3670274.

An outline thereof will be described.

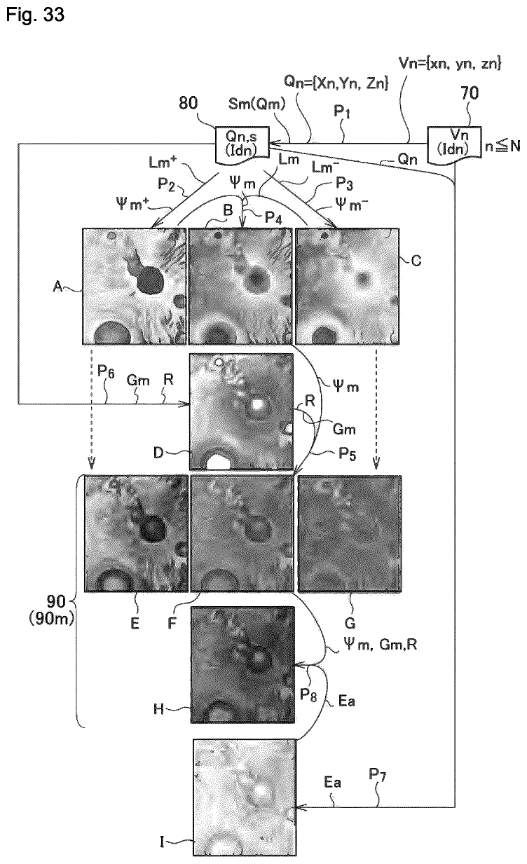

As illustrated in FIG. 33, from an identification number Idn and an altitude difference of a n-th (n=1 to N)-processed two-component vector Vn, a longitude xn, a latitude yn, and a sea level altitude zn are calculated, and the values are mapped to corresponding coordinate points Qn={Xn=xn, Yn=yn, Zn=zn} (plane-rectangular coordinate conversion) in a virtual three-dimensional (3D) X-Y-Z Cartesian three-dimensional coordinate space 80 stored in a memory (not illustrated).

In other words, by storing the identification number Idn of the vector Vn in a storage region corresponding to the coordinate point Qn in the memory, the vector Vn is mapped to the three-dimensional coordinate space 80, and by executing such mapping on a total of N-number of vectors, a vector field 70 is mapped to the three-dimensional coordinate space 80 (process P1).

Furthermore, a curved surface S for connecting a sequence of the total number N or an appropriate number less than N of the coordinate points with Id {Qn: n≤N} in the three-dimensional coordinate space 80 with a required smoothness is obtained by a least-square method or the like, the curved surface S is divided into minute surface areas {Sm: m≤M} of a total number M {M≤N}, respective subject sampling-points Qm are determined, and related information is stored in a memory.

Then, with respect to each surface area Sm, a local area Lm+ on an over-side (Z+ side) of the curved surface S located within a predetermined radius from the subject sampling-point Qm is determined, and an openness (that is, a line-of-sight solid angle with respect to the sky side or a twice derivative value equivalent to the line-of-sight solid angle) Ψm+ around the subject sampling-point Qm defined by the local area Lm+ is obtained (process P2). And the obtained openness is stored as an elevation degree of the surface region Sm.

A resulted image, which represents the elevation degree Ψm+ in a gradation over the entire curved surface S, is defined as a “process-result A” ascribable to a result of the above processing. The image A clearly represents a ridge side of the terrain, that is, a convex portion (of the curved surface S) so as to look like a convexity.

Then, with respect to the surface area Sm, a local region Lm− on a under-side (Z-side) of the curved surface S located within the predetermined radius from the subject sampling-point Qm is determined, and an openness (that is, a line-of-sight solid angle with respect to the ground side or a twice derivative value equivalent to the line-of-sight solid angle) Ψm− around the subject sampling-point Qm defined by the local area Lm− is obtained (process P3). And the obtained openness is stored as a depression degree of the surface region Sm. A resulted image, which represents the depression degree Ψm− in a gradation over the entire curved surface S, is defined as a “process-result C” ascribable to a result of the above processing.

The image C clearly represents a valley side of the terrain, that is, a concave portion (of the curved surface S) so as to look like a concavity.

It should be noted that the image C does not result in a simple inversion of the image A.

Then, with respect to the surface area Sm, the elevation degree Ψm+ and the depression degree Ψm− are synthesized by weighting using a distribution ratio w+:w− (w++w−=0) as (w+Ψm++w−Ψm−), which is appropriately determined (in other words, according to whether to focus on the ridge or the valley). Then, a stereoscopic effect that the local area Lm (Lm+, Lm−) on the over-side and the under-side of the curved surface S located within the predetermined radius brings around the subject sampling-point Qm is determined (process P4), and the stereoscopic effect is stored as an elevation-depression degree Ψm of the surface area Sm.

A resulted image, which represents the elevation-depression degree Ψm in a gradation over the entire curved surface S, is defined as a “process-result B” ascribable to a result of the above processing. The image B clearly represents the convexity portion (of the curved surface S) as a convexity and the concave portion as a concavity, whereby the ridges and valleys of the terrain are accentuated to enhance the visual stereoscopic effect. In the image B, the weight of the synthesis is w+=−w−=1.

Then, regarding the surface region Sm, a maximum slope gradient (or a single derivative value equivalent to the maximum slope) Gm is obtained directly or indirectly through the least-square method (process P6), and stored as a slope gradient Gm of the surface area Sm.

An achromatic color image, which represents the slope gradient Gm in color tone with a reddish color R over the entire curved surface S, is defined as a “process-result D” ascribable to a result of the above processing. The image D also has an effectiveness of visually developing a stereoscopic effect on the terrain (that is, the curved surface S).

Then, by mapping the three-dimensional coordinate space 80 together with the related information (Ψm, Gm, R) onto a two-dimensional plane 90 (process P5), the R-color tone display of the slope gradient Gm is executed in an area 90 m on the two-dimensional plane 90 corresponding to the divided area Sm of the surface S connecting the sequence of the coordinate points Qm, and the brightness of the R-color tone is displayed in a gradation corresponding to the elevation-depression degree Ψm.

The displayed image (displayed image in an achromatic color) is defined as a “process-result F” ascribable to a result of the above processing. The image F imparts the visual stereoscopic effect to the terrain (that is, the curved surface S).

An image E represents a result of mapping process (process P5) of the information of the image D (that is, the R-color tone indicating the slope gradient Gm) and the information of the elevation-depression degree (that is, the elevation degree Ψm+) corresponding to the image A onto the two-dimensional plane 90, and the ridge portion is emphasized.

An image G represents a result of mapping process (process P5) of the information of the image D (the R-color tone indicating the slope gradient Gm) and the information of the elevation-depression degree (that is, the depression degree Ψm−), which corresponds to the image C, onto the two-dimensional plane 90, and the valley portion is emphasized.

In the sequences of the coordinate points Qn, an attribute isoline Ea (contour and outline of the terrain in the present embodiment) obtained by connecting the coordinate points Qn having an equivalent value in the attribute (altitude zn in the present embodiment) extracted from the component of the vector Vn of the vector field 70 is determined. The attribute isoline Ea is stored to read out or display as necessary (process P7).

A process-result I also contributes to understanding the three-dimensional shape of the terrain (or the curved surface S).

Then, on the two-dimensional plane 90, the three-dimensional coordinate space 80 is mapped or displayed together with the relevant information (Ψm, Gm, R), and the attribute isoline Ea is mapped or displayed (process P8). The displayed image (of the achromatic display image) is defined as a “process-result H” ascribable to a result of the above processing. The image H also imparts a visual stereoscopic effect to the terrain (that is, the curved surface S).

Accordingly, the generation scheme of the red stereoscopic image includes a second step, after executing a first step (61) of mapping a vector field (70) into a three-dimensional coordinate space (80) to obtain a corresponding coordinate point sequence. The second step determines an openness around a subject sampling-point defined by an over-side of an area located within a predetermined radius of the subject sampling-point in a local area of a surface connecting the coordinate point sequence as an elevation degree (elevation-depression degree) (A) of the local area.

The generation scheme further includes a third step of determining an openness around the subject sampling-point defined by an under-side of the area located within the predetermined radius of the subject sampling-point in the local area of the surface connecting the coordinate point sequence as a depression degree (C.) of the local area, and a fourth step of synthesizing the elevation degree (A) and the depression degree (C.) by weighting to determine an openness that the areas of the over-side and the under-side in the predetermined radius bring around the subject sampling-point in the local area of the surface connecting the coordinate point sequence as an elevation-depression degree (B) of the local area.

The generation scheme still further includes a fifth step of mapping the three-dimensional coordinate space (80) onto a two-dimensional plane (90), and executing a gradation display (F) corresponding to the elevation-depression degree of the local area on an area on the two-dimensional plane (90) corresponding to the local area of the surface connecting the coordinate point sequence.

Next, a more specific description will be given below. On the basis of Digital Elevation Model (DEM) data, triple parameters of a slope gradient corresponding to the slope gradient Gm, an over-ground openness corresponding to the elevation degree Ψm+ of the first embodiment, and an under-ground openness corresponding to the depression degree Ψm− of the first embodiment are obtained, and distributions of the triple parameters in a plane are stored as gray scale images.

Portions of the ridge and the crest are rendered as white-like, portions of the valley and the hollow are rendered as black-like, and the portions of slopes are rendered more redder, as the slope becomes steeper and steeper, by creating a pseudo-color image. The pseudo-color image is created by putting the difference image of the over-ground openness and the under-ground openness into a gray channel, and by putting the slope into a red channel. Therefore, even a single sheet of image facilitates the stereoscopic effect, by combining such expressions of rendering white, black, and red.

In other words, in a stereoscopic representation method of a stereoscopic map according to the present embodiment, because the meshes are provided between the contours, the difference or the inclination between the adjacent meshes can be represented by a red color tone, and furthermore, the difference of the elevation compared to the surrounding can be represented by a tone of gray scale. The difference of the elevation corresponds to the elevation-depression degree Ψm and is provided with the ridge-valley value in the present embodiment. The difference of the elevation is suggested in that the brighter one is higher than the surrounding (ridge-like) and the darker one is lower than the surrounding (valley-like), and therefore, the stereoscopic effect is generated by multiply synthesis of the contrasting.

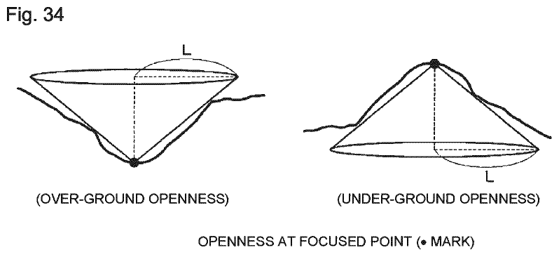

In other words, in the present embodiment, the concept of openness is used. The openness manifests a quantified degree of the extent to which the relevant spot protrudes over the ground and penetrates under the ground compared to the surrounding area. That is, as illustrated in FIG. 34, the over-ground openness represents an extent of the sky to be seen, within a range of a consideration distance L from a subject sampling-point. And the under-ground openness represents an extent of the under-ground, within a range of the consideration distance L, when taking a survey in the soil in a handstand position.

The openness depends on the consideration distance L and the surrounding terrain. In general, the over-ground openness increases as the point protrudes higher from the surrounding and has larger values at the crest and ridge, and has smaller values at the hollow and the bottom of valley. On the other hand, the under-ground openness increases as the point penetrates under the ground and has larger values at the hollow and the bottom of valley, and has smaller values at the crest and the ridge.

That is, terrain cross sections are generated for each of octuple directions on the super-resolution fine mesh mbi included in a range of a certain distance (consideration distance L) from the subject sampling-point, and a maximum value (when viewed from the vertical direction) among inclinations of the lines connecting respective terrain points and the subject sampling-point is determined. Such processing is executed in each of the octuple directions.

In addition, terrain cross sections are generated in each of octuple directions within a range from the subject sampling-point of the smoothing fine elevation-value of the inverted 2 super-resolution fine mesh, and a maximum value (a minimum value when L2 (not illustrated) is viewed from the vertical direction in a three-dimensional view of the ground surface) among inclinations of the lines connecting respective terrain points and the subject sampling-point is determined.

Such processing of generating terrain cross sections and determining the maximum value is executed in each of the octuple directions. In other words, as illustrated in FIG. 32, in the over-ground openness and the under-ground openness, two sampling points A (iA, jA, HA) and B (iB, jB, HB) are supposed. Because the sample interval is approximately 60 cm, the distance between A and B is given by

$$P = {[ {( iA - iB )}^{2} + ( jA - jB ) 2 ]}^{1 / 2} . \qquad ( 1 )$$

FIG. 32 illustrates the relationship between the sampling point A and the sampling point B with respect to the elevation of 0 m.

The elevation angle θ at the sampling point A with respect to the sampling point B is given by θ=tan−1{(HB−HA)/P}. The sign of θ is: (1) positive in the case of HA<HB and (2) negative in the case of HA>HB.

Hereinafter, a set of sampling points residing in an azimuth D within a range of the consideration distance L from a subject sampling-point will be described as a DSL.

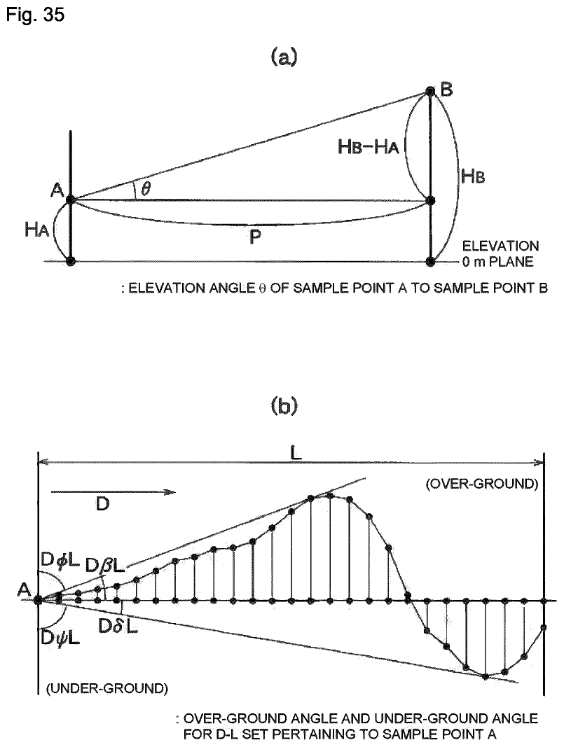

And, furthermore, the DSL will be referred to as “a D-L set of the subject sampling-points”. Here, DβL and DδL are provided as below:
DβL: a maximum value among the elevation angles for respective elements of the DSL pertaining to the subject sampling-point, and
DδL: a minimum value among the elevation angles for respective elements of the DSL pertaining to the subject sampling-point (see FIGS. 35(a) and 35(b)).

Then, the following definition is given.
Definition 1: an over-ground angle and an under-ground angle for the D-L set pertaining to the subject sampling-point shall denote respectively as:

$$D φ L = 90 - D β L ,$$

$$and$$

$$D Ψ L = 90 + D δ L .$$

DφL means a maximum value of a zenith angle in which the sky in the azimuth D can be seen within the consideration distance L from the subject sampling-point. The generally referred horizon angle corresponds to the ground angle, when the distance L is infinity. Further, DΨL means a maximum value of the nadir angle in which the soil in the azimuth D can be seen within the consideration distance L from the subject sampling-point. As the distance L increases, the number of sampling points belonging to the DSL increases, and thus, DβL has a non-decreasing property and DδL has a non-increasing property.

Therefore, both DφL and DΨL have non-increasing properties for L.

A high angle in academical term of land surveying is a concept defined with reference to a horizontal plane passing through the subject sampling-point, and not strictly coincident with θ. In addition, for strict discussion of the over-ground angle and the under-ground angle, the curvature of the Earth should also be considered. And therefore, Definition 1 is not necessarily an accurate description. Definition 1 is a concept defined doggedly on the premise of carrying out topographic analysis using the DEM scheme.

The over-ground angle and the under-ground angle are the concepts of the specified azimuth D, but a following definition is introduced as an extension of the above-mentioned concept.
Definition II: the over-ground openness and the under-ground openness for the consideration distance L pertaining to the subject sampling-point are respectively defined as:

$$φ L = ( 0 φ L + 45 φ L + 90 φ L + 135 φ L + 180 φ L + 225 φ L + 270 φ L + 325 φ L ) / 8 ,$$

$$and$$

$$Ψ L = ( 0 Ψ L + 45 Ψ L + 90 Ψ L + 135 Ψ L + 180 Ψ L + 225 Ψ L + 270 Ψ L + 325 Ψ L ) / 8.$$

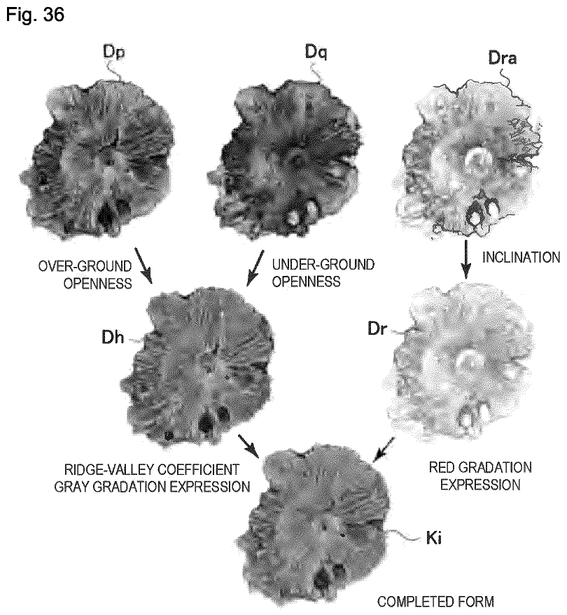

In other words, as illustrated in FIG. 36, a synthesized image Dh is generated by multiplying and synthesizing over-ground openness image data Dp (white emphasized on the ridge: also referred to as over-ground openness image Dp) and under-ground openness image data Dq (dark emphasized on the bottom: also referred to as under-ground openness image Dq), a slope-gradient emphasis image Dr is generated in which red is emphasized as the slope gradient of slope-gradient image data Dra (also referred to as slope-gradient image Dra) increases, and the slope-gradient emphasis image Dr and the synthesized image Dh are synthesized.

In other words, due to processing such as that illustrated in FIG. 36, the super-resolution stereoscopic visualization image Ki (also referred to as super-resolution red stereoscopic image) described above is obtained and displayed on a display.

Therefore, even a single sheet of image that facilitates the stereoscopic effect can be generated by combining such expressions. This allows a degree of elevation of unevenness and a degree of inclination to be comprehended at a glance.

Next, processing by the super-resolution image generator 151 will be described in detail.

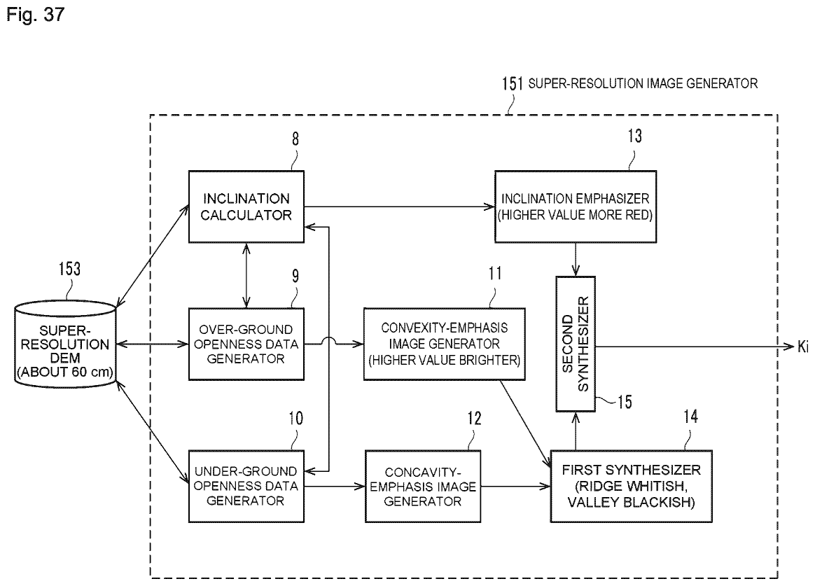

FIG. 37 is a block diagram of a program of the super-resolution image generator 151.

As illustrated in FIG. 37, the super-resolution image generator 151 includes an over-ground openness data generator 9 for reading the smoothing elevation-values zhi contained in the super-resolution DEM data in the memory 153 (layer), an under-ground openness data generator 10, and an inclination calculator 8. The super-resolution image generator 151 further includes a convexity-emphasis image generator 11, a concavity-emphasis image generator 12, an inclination emphasizer 13, a first synthesizer 14, and a second synthesizer 15.

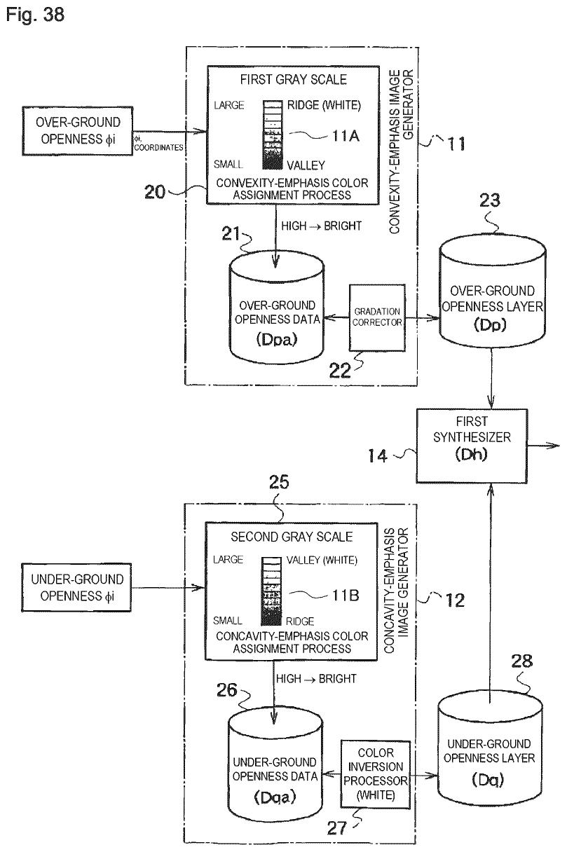

FIG. 38 is a schematic configuration diagram explaining the convexity-emphasis image generator 11 and the concavity-emphasis image generator 12. However, the first synthesizer 14 and the like are illustrated in FIG. 38.

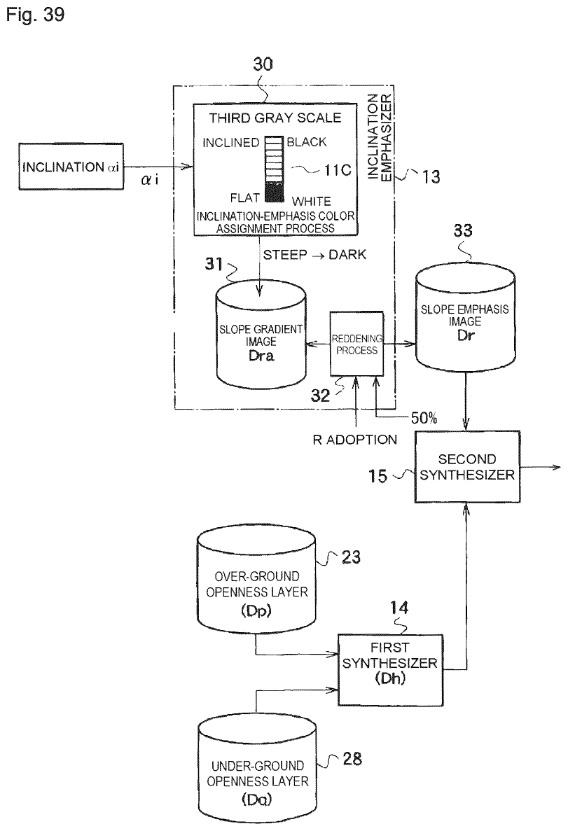

FIG. 39 is a schematic configuration diagram explaining the inclination emphasizer 13. However, the first synthesizer 14, the second synthesizer 15, and the like are illustrated in FIG. 39.

As illustrated in FIG. 38, the convexity-emphasis image generator 11 includes a first gray scale 11A and a gradation corrector 22 while the concavity-emphasis image generator 12 includes a second gray scale 11B and a color inversion processor 27.

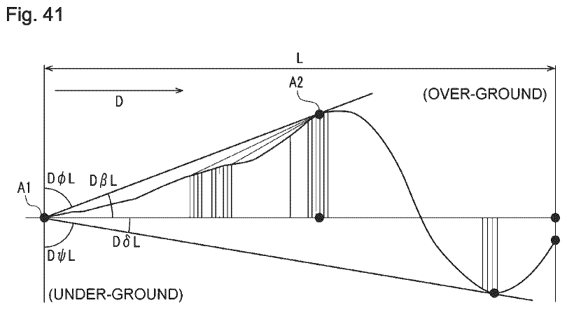

The over-ground openness data generator 9 generates terrain cross sections for each of octuple directions on the adjustment fine mesh mei included in a range of a certain distance (consideration distance L) from the subject sampling-point. And the over-ground openness data generator 9 determines a maximum value (when viewed from the vertical direction) among inclinations of the lines connecting respective terrain points and the subject sampling-point (see FIG. 41). Such processing of generating terrain cross sections and determining the maximum value is executed in each of the octuple directions.

In addition, the under-ground openness data generator 10 generates the terrain cross sections in each of octuple directions within a range from the subject sampling-point of the smoothing elevation-value zhi of the inverted adjustment fine mesh mei to the certain distance. And the under-ground openness data generator 10 determines a maximum value (a minimum value when L2 (not illustrated) is viewed from the vertical direction in a three-dimensional view of the ground surface) among inclinations of the lines connecting respective terrain points and the subject sampling-point (see FIG. 41). Such processing of generating terrain cross sections and determining the maximum value is executed in each of the octuple directions. As illustrated in FIG. 41, the maximum values are obtained for each da (for example, 0.5555 m).

The inclination calculator 8 obtains an average inclination (slope gradient) of each plane of squares adjacent to the subject point (adjustment fine mesh mei) as described above. The average inclination (slope gradient) is an inclination of a surface approximated from quadruple points using the least-square method.

The convexity-emphasis image generator 11 described earlier includes a convexity-emphasis color assignment process 20 as illustrated in FIG. 38.

As illustrated in FIG. 38, the convexity-emphasis color assignment process 20 includes the first gray scale 11A for expressing the ridge and the bottom of valley by brightness. Brightness (luminance) corresponding to a value of the over-ground openness Ψi is calculated every time the over-ground openness data generator 9 obtains the over-ground openness Ψi (an average angle when viewing the range of the distance L from the subject point in octuple directions: an index for determining whether the residing point is at a high position).

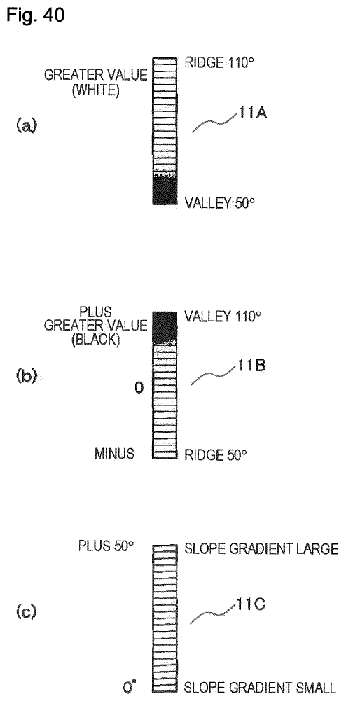

For example, when a value of the over-ground openness falls within a range of about 40 degrees to 120 degrees, the first gray scale 11A is associated with a range of 50 degrees to 110 degrees, which is assigned to 255 gradations (see FIG. 40(a)).

In other words, the greater the value of the over-ground openness as the portion of the ridge (convex portion), the whiter the color.

In addition, the convexity-emphasis color assignment process 20 of the convexity-emphasis image generator 11 reads over-ground openness, assigns color data based on the first gray scale 11A (see FIG. 40(b)), and stores the color data in an over-ground openness file 21 (over-ground openness image data Dpa).

On the other hand, the gradation corrector 22 of the convexity-emphasis image generator 11 stores, in a memory 23, the over-ground openness layer Dp that is an image in which the color gradation of the over-ground super-resolution data Dpa is inverted. That is, the over-ground openness layer Dp (over-ground openness image Dp) adjusted the ridge to be whiter is obtained. The expression layer is described as a layer because it is an image that is synthesized with other images.

The concavity-emphasis image generator 12 includes a concavity-emphasis color assignment process 25 as illustrated in FIG. 38. The concavity-emphasis color assignment process 25 includes the second gray scale 11B (see FIG. 40(b)) for expressing the bottom of valley and ridge by brightness. Brightness corresponding to a value of the under-ground openness Ψi is calculated every time the under-ground openness data generator 10 obtains the under-ground openness Ψi (an average of octuple directions from the subject point).

For example, when a value of the under-ground openness falls within a range of about 40 degrees to 120 degrees, the second gray scale 11B is associated with a range of 50 degrees to 110 degrees (see FIG. 40(b)), which is assigned to 255 gradations.

That is, since the value of the under-ground openness has the larger value in the portion of the bottom of valley (concavity), the color becomes darker.

In addition, as illustrated in FIG. 38, the concavity-emphasis image generator 12 reads under-ground openness, assigns color data based on the second gray scale 11B, and stores the color data in an under-ground openness file 26. Next, the color inversion processor 27 corrects the color gradation of the under-ground openness image data Dqa and stores the color gradation in a memory 28.

When the color becomes too dark, the color is set to the degree of correction of the tone curve. The layer is stored as an under-ground openness layer Dq (also referred to as an under-ground openness image).

The inclination emphasizer 13 includes an inclination-emphasis color assignment process 30 as illustrated in FIG. 39.

The inclination-emphasis color assignment process 30 includes a third gray scale 11C for expressing the degree of inclination in accordance with the degree of brightness (see FIG. 40(c)), and every time the inclination calculator 8 obtains the slope gradient (average in quadruple directions from the subject point), the brightness (luminance) of the third gray scale 11C corresponding to the value of the slope gradient is calculated.

For example, when the value of the slope gradient αi falls within a range of about 0 degree to 70 degrees, the third gray scale 11C is associated with a range of 0 degree to 50 degrees, which is assigned to 255 gradations. That is, 0 degree is white, and equal to or more than 50 degrees is black. The larger the slope gradient αi, the darker the color.

In addition, as illustrated in FIG. 39, the inclination-emphasis color assignment process 30 of the inclination emphasizer 13 reads an slope gradient (inclination) and assigns color data based on the third gray scale 11C.

Next, a reddening process 32 emphasizes R by an RGB color mode function (however, sometimes 50 percent emphasis may be used). That is, the slope-gradient emphasis image Dr (also simply referred to as a slope-gradient image Dr) in which the steeper the slope, the more the red is emphasized is stored in a memory 33 (layer).

The first synthesizer 14 obtains a synthesized image Dh synthesized by multiplying the over-ground openness image Dp and the under-ground openness image Dq. At the same time, the balance of both images Dp and Dq is adjusted so as to avoid collapsing the valley part.

The “multiply” described above is a term used in Photoshop (registered trademark) for a layer mode and is an OR operation in numerical processing.

For example, a subdued red color provided with a hue of zero degree, a chroma saturation of 50%, and a brightness of 80%.

When each color value of RGB is specified in the range of 0 to 255, RED is set to “204”, GREEN is set to “102”, and BLUE is set to “102”. The HEX value (WEB color in hexadecimal/HTML color code) is set to #CC6666. Alternatively, the CMYK values used for color printing are approximately set to cyan “C 20%”, magenta “M 70%”, yellow “Y 50%” and black “K 0%”.

The second synthesizer 15 synthesizes (synthesizes by multiplying) synthesized image Dh and the slope-gradient emphasis image Dr in which red is emphasized as the slope gradient increases, and causes the display processor to display the super-resolution stereoscopic visualization image Ki.

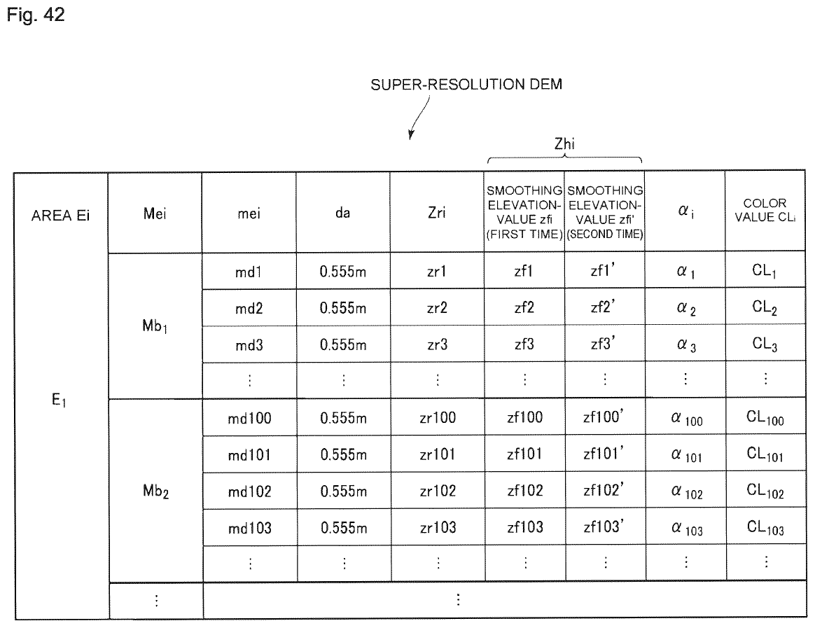

In other words, as illustrated in FIG. 42, the memory 153 of the super-resolution image generator 151 stores, as super-resolution DEM data, the area Ei (number), the square adjustment super-resolution mesh Mei (number), the adjustment fine mesh mei (number), the division width da, zri, the smoothing elevation-value zhi, the slope gradient αi, the color value of the slope gradient, the color value of the elevation-depression degree (not illustrated: over-ground openness, under-ground openness), and the like. A set of the super-resolution DEM data is also simply referred to as a super-resolution DEM. The super-resolution DEM is colored and displayed by the display processor.

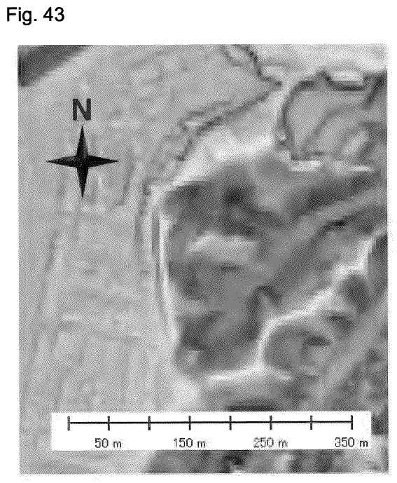

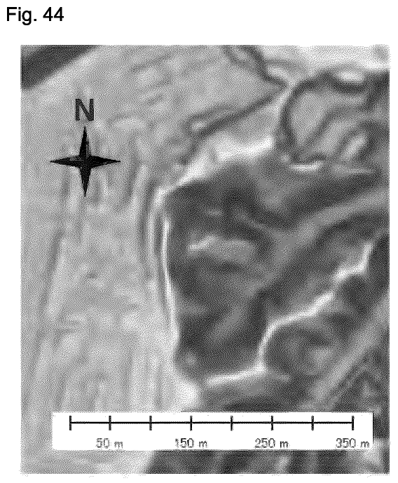

An effect of performing respective processes such as those described above will be described with reference to FIGS. 43 and 44.

FIG. 43 is an explanatory diagram of a red stereoscopic image using a 5 m-DEM generated based on Japanese Patent No. 6692984. FIG. 44 is an explanatory diagram of a super-resolution image generated by the high-speed super-resolution image stereoscopic visualization processing system according to the present embodiment.

Since FIG. 44 uses the smoothing elevation-value zhi by the 9×9 bilinear interpolation process and the 9×9 moving-average process, a clean image without jaggies is realized as compared to FIG. 43.

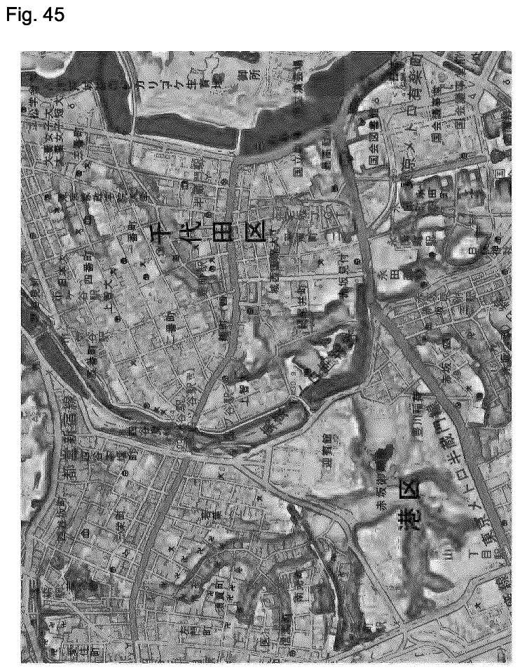

Such an image is preferably used by, for example, superimposing the image on a general map as illustrated in FIG. 45. As illustrated in FIG. 45, a stereoscopic effect is produced because unevenness of the map as a whole is clearly defined, and height and subsidence of the ground (including roads) in urban areas can be visually and stereoscopically comprehended.

Note that although projection conversion is executed between the super-resolution red relief image map generation process and the super-resolution slope gradient calculation process in the first embodiment described above, the projection conversion may be executed after the super-resolution red relief image map generation process.

### Second Embodiment

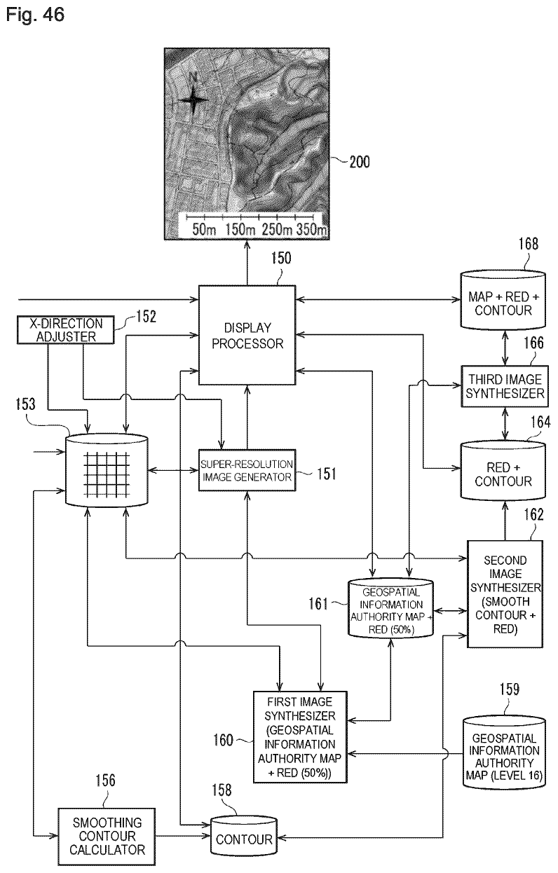

FIG. 46 is a schematic configuration diagram of a second embodiment.

In FIG. 46, the super-resolution rasterization processor 135, the moving-average unit 134, and the consideration distance grid-number calculator 148 in FIG. 3 are not illustrated.

As illustrated in FIG. 46, the memory 153 (not illustrated) of the super-resolution image generator 151, the super-resolution image generator 151, and the X-direction adjuster 152 will be described.

In addition, FIG. 46 illustrates a smoothing-contour calculator 156, a smoothing-contour data memory 158, a Geospatial-Information-Authority standard map memory 159, a first image synthesizer 160 (Geospatial Information Authority map+red), a first synthetic image memory 161 (Geospatial Information Authority map+red), a second image synthesizer 162 (smoothing contour+red), a second synthetic image memory 164 (smoothing contour+red), a third image synthesizer 166 (contour+Geospatial Information Authority map+red), a third synthetic image memory 168 (contour+Geospatial Information Authority map+red), and the display processor 150.

The Geospatial-Information-Authority standard map memory 159 stores vector data of a 1/25000 standard map Gki (level 16).

The smoothing-contour calculator 156 designates the adjustment fine mesh mei in the memory 153 and retrieves an adjustment fine mesh mei with the same elevation-value as the smoothing elevation-value zhi of the super-resolution fine mesh representative point dpij assigned to the designated adjustment fine mesh mei.

Then, the adjustment fine meshes mei to be connected are determined by a standard deviation calculation process and the like with respect to the adjustment fine meshes mei to delineate a closed curve.

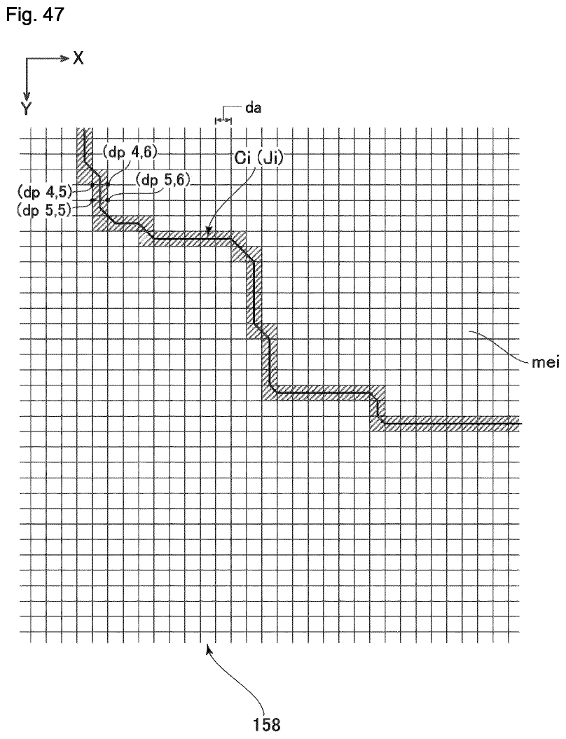

In this case, as illustrated in FIG. 47, for example, among the super-resolution fine mesh representative points (dp4, 5), (dp4, 6), (dp5, 5), and (dp5, 6) of the four corners of the adjusted fine mesh mei, for example, a line connecting (dp4, 5) and (dp4, 6) is adopted as a line of entry and a line connecting (dp5, 5) and (dp5, 6) is adopted as a line of exit.

Then, an elevation-value between (dp4, 5) and (dp4, 6) is interpolated, an elevation-value between (dp5, 5) and (dp5, 6) is interpolated, and a line (y=ax+b) which connects points having substantially the same elevation is generated and connected.

Then, a set of straight lines of the adjustment fine meshes mei to be the closed curve is vectorized (function), and the vectorized set of straight lines is stored in the smoothing-contour data memory 158 as smoothing-contour information Ji by a moving-average process (a process similar to step S60 in FIG. 1 and step S280 in FIG. 5). When the smoothing-contour information Ji is converted into an image, it is referred to as a smoothing contour Ci.

In the vectorization, when the adjacent adjustment fine meshes mei to be connected are in the X-direction or the Y-direction, the center coordinates (x, y) are connected by a straight line. And when the adjacent adjustment fine meshes mei to be connected are in the oblique direction, a center coordinate of two corner points of the adjustment fine mesh mei in the connecting direction side and a center coordinate between the two points of the adjustment fine mesh mei in the oblique direction to be connected are connected to delineate a straight line.

And, the set of the lines is used to define a function (or an approximate function).

In other words, the smoothing-contour information Ji implements the contours, which are delineated by connecting the straight lines passing through the adjustment fine meshes mei without performing curvature maximization processing, such as a spline curve, a Bezier curve and the like, known in the conventional manner.

Simultaneously, a color value is assigned. In other words, the smoothing-contour information Ji includes the area Ei, the adjustment fine mesh mei, the size (0.5555 m), the elevation-value zhi, and the connection direction (up (or down) in the X-direction, up (or down) in the Y-direction, or obliquely to the right or obliquely to the left).

The interval of the smoothing contours Ci may be 1 m, 2 m, 3 m, . . . .

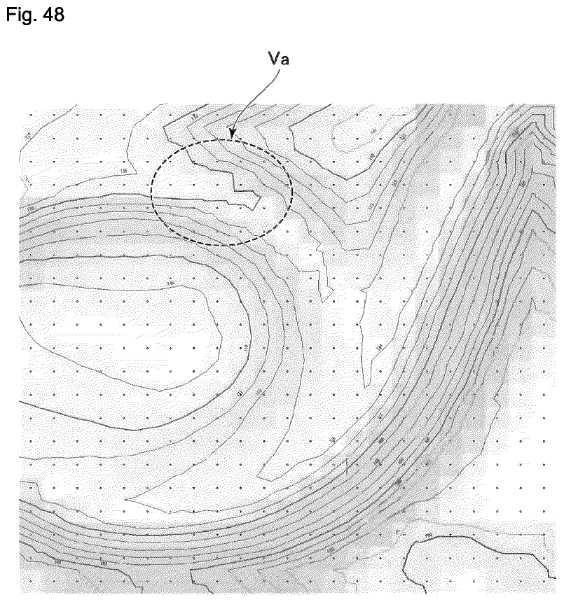

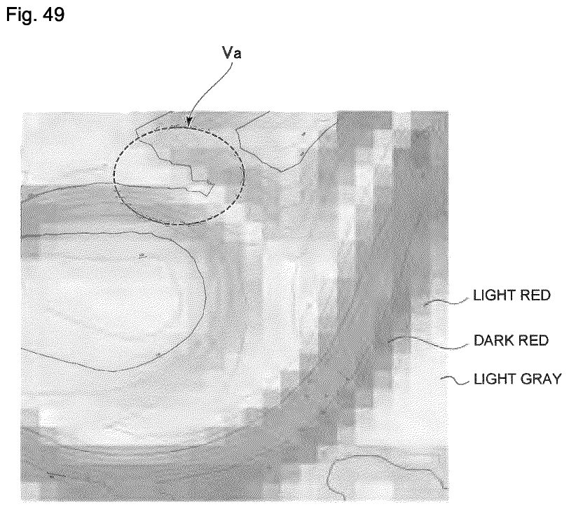

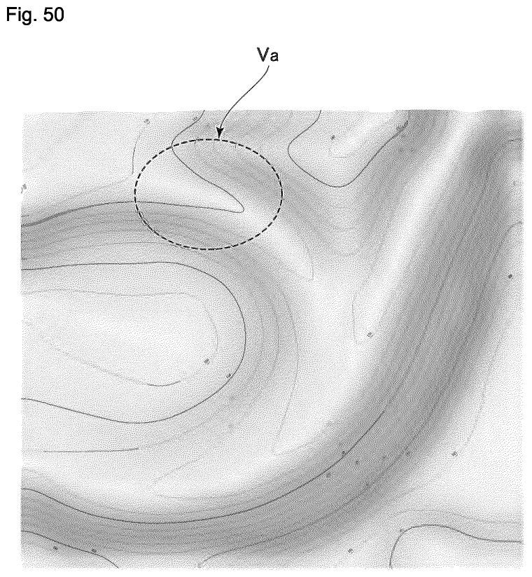

An example of superimposing contours (vectors) of the smoothing-contour information Ji described above on a red image not subjected to a smoothing process is illustrated in FIG. 48. In addition, FIG. 49 illustrates an enlarged view of FIG. 48. Furthermore, FIG. 50 illustrates an image resulting from subjecting contours to a smoothing process using the elevation-value zhi. However, FIG. 50 represents an image after performing a moving-average twice.

As illustrated in FIGS. 48 and 49, the contours are jagged as a whole (for example, a location denoted by Va). However, the contours are smooth as a whole in FIG. 50 (see Va).

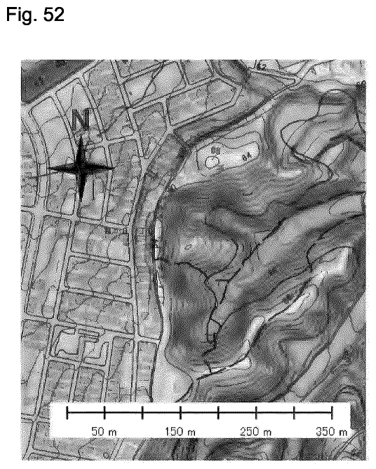

FIG. 52 represents an image created by synthesizing such contours with a super-resolution red image created by the high-speed super-resolution image stereoscopic visualization processing system according to the present first embodiment. FIG. 52 is an image based on a super-resolution DEM of 5 m-DEM. Note that the interval of the contours is several meters (for example, 1 m, 2 m, or 3 m).

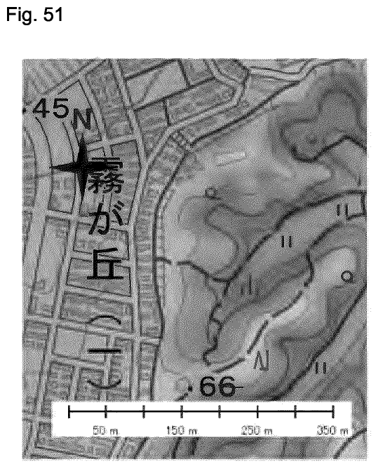

In addition, FIG. 51 is a diagram synthesizing contours of a 1/25000 map and a red image generated based on 10 m-DEM. Note that the interval of the contours is 10 m.

As illustrated in FIG. 52, smooth contours are finely displayed and hues (dark red when a depression is deep and whitish color when a projection is high) of slope gradients of unevenness are finely but clearly identifiable.

In other words, since the interval of the contours is several meters (for example, 1 m, 2 m, or 3 m), the contours of the present embodiment can be used as a contour map at 1/10,000.

In addition, the first image synthesizer 160 (Geospatial Information Authority map+red) generates a “Geospatial Information Authority map+red synthetic image” Gfi, which is synthesized by multiplying an image in the memory 153 (not illustrated) and image data of vector data generated from the standard map Gki (level 16) in the Geospatial-Information-Authority standard map memory 159 and stores the generated “Geospatial Information Authority map+red synthetic image” Gfi in the first synthetic image memory 161 (Geospatial Information Authority map+red) (see FIG. 52).

In that regard, the first image synthesizer 160 (Geospatial Information Authority map+red) reduces the color value of the image in the memory 153 by 50% so as to be different from the color (for example, orange) when a vector of the standard map (city map of buildings, roads, and the like) is imaged. For example, a subdued red color provided with a hue of zero degree, a chroma saturation of 50%, and a brightness of 80%.

When each color value of RGB is specified in the range of 0 to 255, RED is set to “204”, GREEN is set to “102”, and BLUE is set to “102”. The HEX value (WEB color in hexadecimal/HTML color code) is set to #CC6666. Alternatively, the CMYK values used for color printing are approximately set to cyan “C 20%”, magenta “M 70%”, yellow “Y 50%” and black “K 0%”.

The second image synthesizer 162 (smoothing contour+red) generates a “smoothing contour+red” image GaCi synthesized by multiplying the “Geospatial Information Authority map+red synthesis image” GFi in the first synthetic image memory 161 (Geospatial Information Authority map+red) and data obtained by imaging smoothing contour information CJi in the smoothing contour data memory 158, and stores the generated “smoothing contour+red” image GaCi in the second synthetic image memory 164 (smooth contour+red).

The third image synthesizer 166 (contour+Geospatial Information Authority map+red) stores a “standard map+red+smooth contour” image Gami synthesized by multiplying the “Geospatial Information Authority map+red synthesis image” GFi in the first synthetic image memory 161 (Geospatial Information Authority map+red) and the “smooth contour+red” image GaCi of the second synthetic image memory 164 (smooth contour+red) in the third synthetic image memory 168 (see FIG. 49).

In addition, the Geospatial-Information-Authority standard map memory 159 stores vector data of a 1/25000 standard map (level 16).

There is no jagged appearance even when displaying the vector data of buildings, roads, and the like of the Geospatial Information Authority base map read from the displaying memory. In other words, the resolution is matched with the complex linear road outlines and the building outlines of the 1/25000 standard map (level 16).

Further, there is no jagged appearance (jaggies) even when enlarged. Therefore, a situation of the cliff, a situation of the plane, a slope of the road, and the like can be confirmed in detail.

For this reason, it can be said that a map almost similar to the map with a scale of 1/10,000 that the Geospatial Information Authority has been abandoned is generated.

While an example of a high-speed conversion into super resolution using the DEM of ground above ground has been described in the embodiments presented above, a high-speed conversion into super resolution may also be performed using the DEM of the seabed.

### Other Embodiments

### (Lab Colorization)

Images become clearer when a Lab colorization process is applied to the high-speed super-resolution image stereoscopic visualization processing system according to each present embodiment described above. In the present embodiment, the system will be referred to as a Lab color-imparted high-speed super-resolution image stereoscopic visualization processing system.

For example, a valley becomes too dark, a water system is difficult to track, and ensure that it is not difficult to follow a channel of a valley due to being dark.

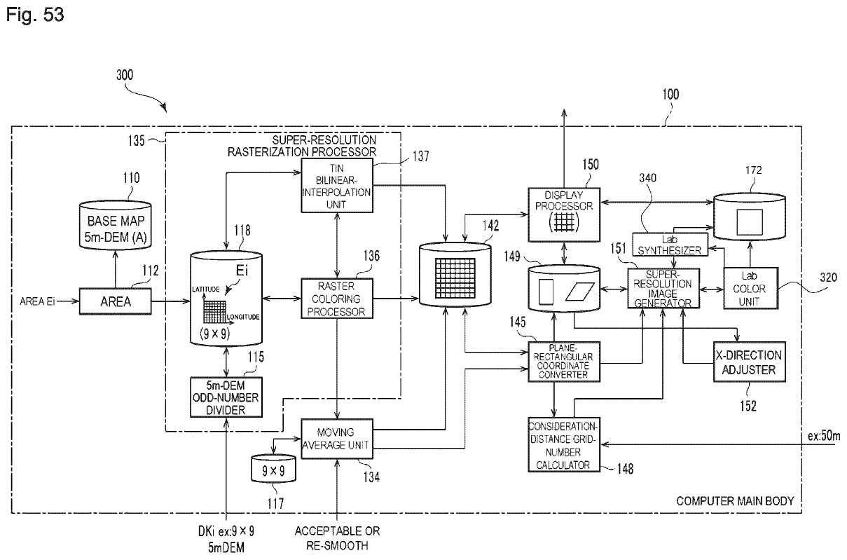

FIG. 53 is a schematic configuration diagram of a Lab color-imparted high-speed super-resolution image stereoscopic visualization processing system according to another embodiment.

In FIG. 53, duplicate explanations are omitted for parts denoted by the same reference numerals as described above.

The present embodiment includes a Lab color unit 320 and a Lab synthesizer 340 in addition to the respective system components illustrated in FIG. 3 and described above.

Note that it is assumed that data (including square adjustment super-resolution mesh Mei) in the memory 153 described above is generated in a memory (not illustrated) of the super-resolution image generator 151.

Every time the adjustment fine mesh mei of the square adjustment super-resolution mesh Mei is designated as a subject sampling point, the Lab color unit 320 generates a super-resolution L*a*b* color image Li in which the over-ground openness determined by the super-resolution image generator 151 is converted into a* of Lab color, the under-ground openness is converted into b*, and a slope gradient (also referred to as inclination) is converted into L′, and stores the generated image in a memory not illustrated.

The Lab synthesizer 340 synthesizes the super-resolution L*a*b* color image Li and the super-resolution stereoscopic visualization image Ki (super-resolution red stereoscopic visualization image) (the synthesized image is referred to as a Lab color red super-resolution image Lki), and stores the synthesized image as a Lab color red super-resolution image Lki in a memory 172.

The display processor 150 includes a display memory (not illustrated), reads data in accordance with an entered image type into the display memory, and displays an image (for example, the L*a*b* color red super-resolution image Lki) of a color value assigned to the data on a screen of the display.

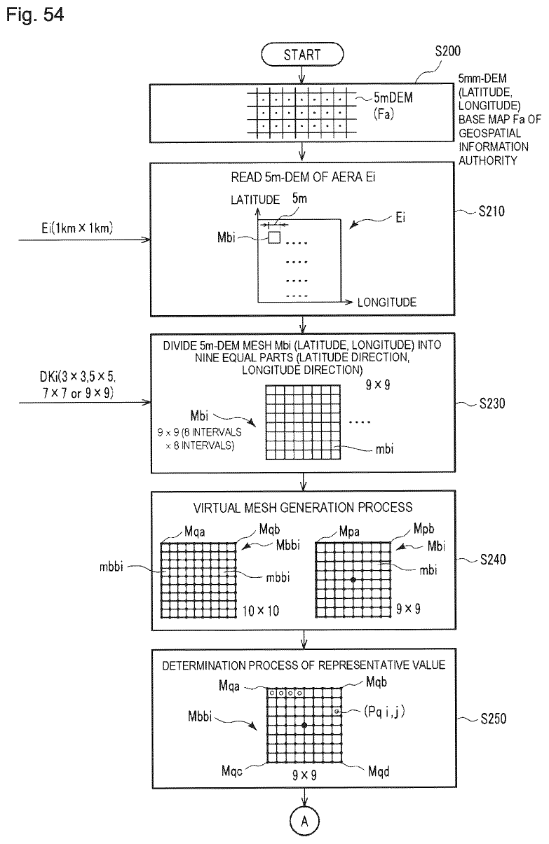

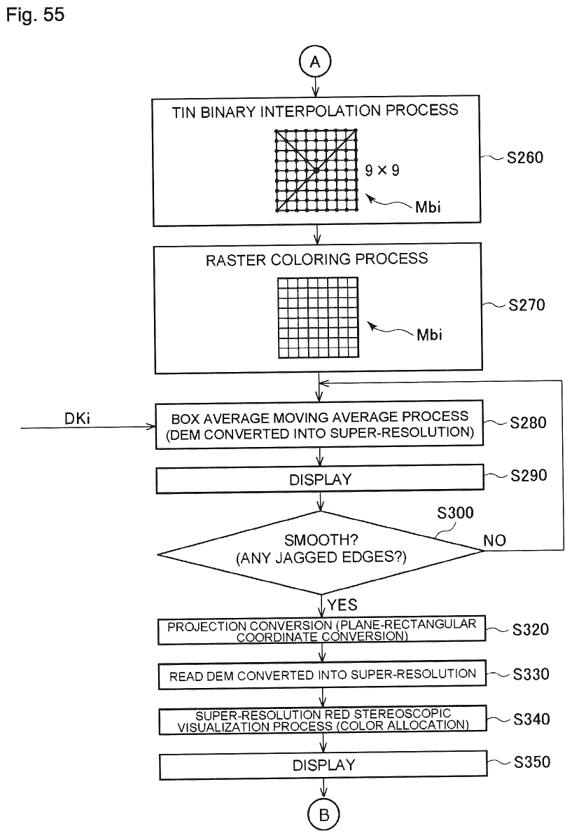

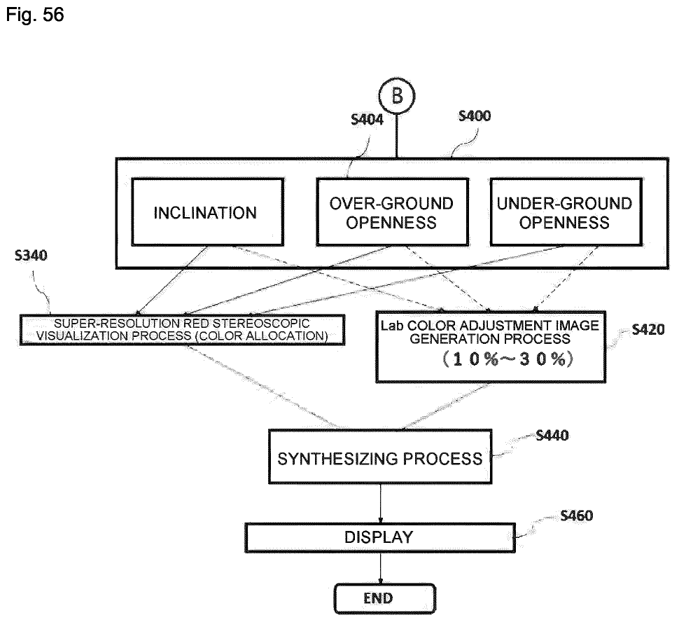

In other words, after processing illustrated in FIG. 54 (similar to FIG. 4) and FIG. 55 (similar to FIG. 5) is performed, the Lab color unit 320 performs a Lab color red super-resolution image process illustrated in FIG. 56. Since FIG. 54 represents a process similar to that of FIG. 4 and FIG. 55 represents a process similar to that of FIG. 5, redundant descriptions will not be repeated.

In step S320 in FIG. 56, the super-resolution image generator 151 reads each of the plane-rectangular super-resolution fine meshes mdi of each of the plane-rectangular super-resolution meshes Mdi (S330) and performs the super-resolution image stereoscopic visualization process (S400).

At this point, the X-direction adjuster 152 generates, in the memory 153 (not illustrated), the square adjustment super-resolution mesh Mei by adjusting the plane-rectangular super-resolution mesh Mdi (for example, a rectangle or a trapezoid) to assume a square.

### (Super-Resolution Image Stereoscopic Visualization Process S400 of Super-Resolution Image Generator 151)

The super-resolution image generator 151 determines the slope gradient αi (α1, α2, . . . ) of each of all adjustment fine meshes mei by the slope gradient calculation process described above (see FIG. 39(b)).

In addition, the super-resolution image generator 151 determines the over-ground openness and the under-ground openness of each of adjustment fine meshes mei by the process described above and determines a ridge-valley value (also referred to as an elevation-depression degree) (see FIG. 38).

Furthermore, the super-resolution red stereoscopic visualization process (S340) illustrated in FIG. 56 assigns a gradation color value (reddish color) indicating a color value of a combination of the ridge-valley value and the slope gradient (also referred to as inclination) to the adjustment fine mesh mei. In other words, imaging is performed. In the present embodiment, as described above, an image of over-ground openness with super resolution is simply referred to as an over-ground openness image Dp, an image of under-ground openness is simply referred to as an under-ground openness image Dq, and an image of a slope gradient is simply referred to as a slope-gradient emphasis image Dr.

On the other hand, the Lab color unit 320 performs a L*a*b* color adjustment image generation process (S420).

The L*a*b* color adjustment image generation process involves reading image data of an adjustment fine mesh mei (fine mesh: super-resolution mesh) of the over-ground openness image Dp and obtaining a* data assigned to the a* channel for each read.

In addition, image data of an adjustment fine mesh mei (fine mesh) of the under-ground openness Dq is read and b* data assigned to the b* channel is obtained for each read.

Furthermore, image data of the slope-gradient emphasis image Dr is read and L* data assigned to the L* channel is obtained for each read.

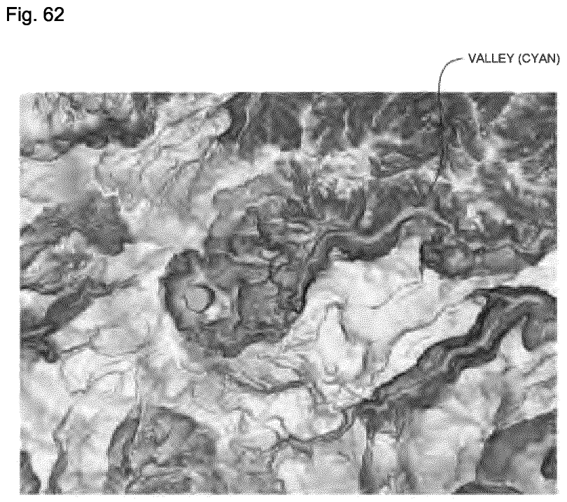

Every time a* data, b* data, and L* data are obtained, the data is defined in a L*a*b* space to obtain super-resolution L*a*b* color image data Li (see FIG. 62).

Then, the Lab synthesizer 340 synthesizes with the super-resolution red stereoscopic visualization image Ki obtained in step S340 and stores the synthesized image in the memory 172 as a L*a*b* color red super-resolution image KLi (S440).

The display processor 150 displays the L*a*b* color red super-resolution image KLi and the like on the screen (S460).

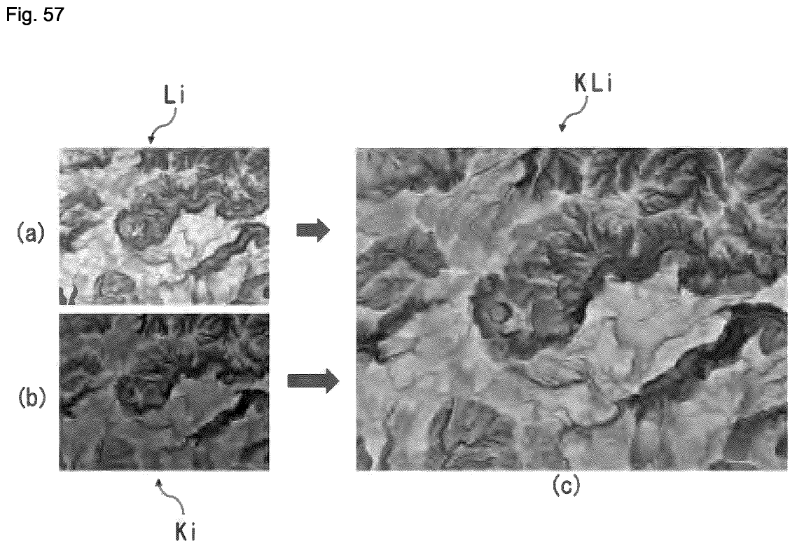

FIG. 57 illustrates, using images, a process of obtaining the L*a*b* color red super-resolution image KLi.

FIG. 57(a) illustrates the super-resolution L*a*b* color image data Li, FIG. 57(b) illustrates the super-resolution stereoscopic visualization image Ki (super-resolution red stereoscopic visualization image), and FIG. 57(c) illustrates the L*a*b* color red super-resolution image KLi obtained by synthesizing the images of FIGS. 57(a) and 57(b). The L*a*b* color red super-resolution image KLi is an image with L*a*b* transparency reduced by about 30%.

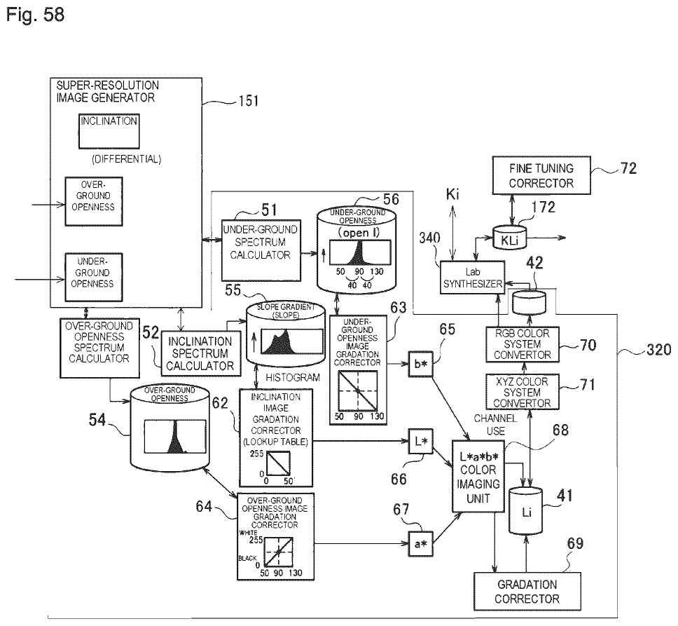

The description of the Lab color adjustment image generation process (S420) described earlier will be supplemented using FIG. 58. FIG. 58 is a configuration diagram of the Lab color unit 320. However, the super-resolution image generator 151, the L*a*b* synthesizer 340 (also simply referred to as the synthesizer 340), and the like are described.

As illustrated in FIG. 58, the Lab color unit 320 includes an inclination image gradation corrector 62, an over-ground openness image gradation corrector 64, an under-ground openness image gradation corrector 63, an L* channelizing unit 66, a b* channelizing unit 65, an a* channelizing unit 67, and an L*a*b* color imaging unit 68.

Furthermore, a gradation corrector 69, an XYZ color system converter 71, an RGB color system converter 70, a fine tuning corrector 72, an inclination spectrum calculator 52, an under-ground openness spectrum calculator 51, an over-ground openness spectrum calculator 53, and the like are provided to adjust images so that valleys and depressions with a high under-ground openness become cyan while ridges and peaks with a high over-ground openness become red. Valley slopes and the like with low over-ground openness are greenish in color.

The inclination spectrum calculator 52 calculates a spectrum distribution (also referred to as a slope-gradient spectrum) of the slope-gradient emphasis image Dr with super resolution in the memory 153 (not illustrated) of the super-resolution image generator 151 and stores the calculated spectrum distribution in a memory 55.

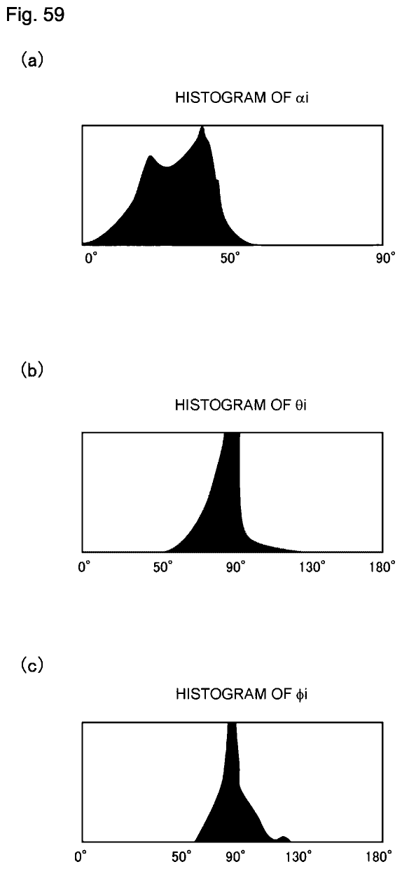

The slope-gradient spectrum of the slope-gradient emphasis image Dr is shown in FIG. 59(a) as a histogram with the slope gradient (0 degree to 90 degrees) on an axis of abscissa and pixel frequency (n) on an axis of ordinate. As illustrated in FIG. 59(a), the slope gradient αi is essentially distributed between 0 degree and 50 degrees.

The over-ground openness spectrum calculator 53 calculates a spectrum distribution (also referred to as an over-ground openness spectrum) of the over-ground openness image Dp in the memory 153 of the super-resolution image generator 151 and stores the calculated spectrum distribution in a memory 54.

The over-ground openness spectrum is shown in FIG. 59(b) as an over-ground openness histogram with openness (0 degree to 180 degrees) on an axis of abscissa and pixel frequency (n) on an axis of ordinate. As illustrated in FIG. 59(b), the over-ground openness θi is essentially distributed between 0 degree and 90 degrees (center is 90 degrees: side of 90 degrees to 130 degrees is sharp).

The under-ground openness spectrum calculator 51 calculates a spectrum distribution (also referred to as an under-ground openness spectrum) of the under-ground openness image Dq in the memory 153 and stores the calculated spectrum distribution in a memory 56.

The under-ground openness spectrum is shown in FIG. 59(c) as an under-ground openness histogram with under-ground openness (0 degree to 180 degrees) on an axis of abscissa and pixel frequency (n) on an axis of ordinate. As illustrated in FIG. 59(c), the under-ground openness φi is essentially distributed between 50 degrees and 130 degrees (center is 90 degrees: side of 50 degrees to 90 degrees is sharp).

### (Description of Image Gradation Unit)

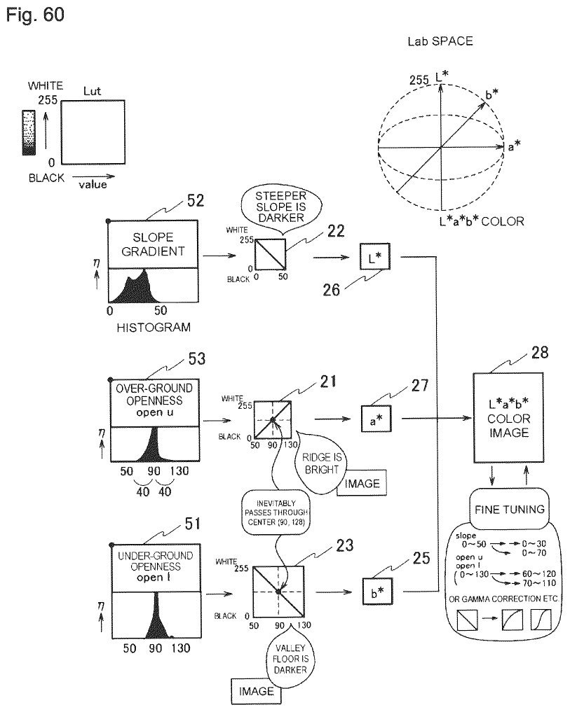

The inclination image gradation corrector 62 corrects gradation so that the steeper the slope, the darker the color. In other words, a linear conversion is performed in which an input side (axis of abscissa) is set to slope gradient 0 degree to slope gradient 50 degrees, an output side is set to 0 (black) to 255 (white), and a slope gradient αi of 50 degrees is converted to “0” while a slope gradient αi of 0 degree is converted into a maximum value of 255 (see FIG. 60(a)). Specifically, a look-up table is used.

A histogram of slope gradient obtained by the conversion described above is illustrated in FIG. 59(a).

The over-ground openness image gradation corrector 63 corrects gradation so that ridgelines are light. In other words, a linear conversion is performed in which an input side (axis of abscissa) is set to over-ground openness 50 degrees to over-ground openness 130 degrees, an output side is set to 0 (black) to 255 (white), and an over-ground openness θi of 50 degrees is converted to “0” while an over-ground openness θi of 130 degrees is converted into a maximum value of 255 (see FIG. 60(b)).

However, conversion is performed to “120 degrees” when the over-ground openness θi is 90 degrees. Specifically, a look-up table is used. In other words, as illustrated in FIG. 60(b), a center of the conversion line passes through (90 degrees, 120). An over-ground histogram obtained by the conversion described above is illustrated in FIG. 59(b).

The under-ground openness image gradation corrector 64 corrects gradation so that a line of a valley is dark. In other words, a linear conversion is performed in which an input side (axis of abscissa) is set to under-ground openness 50 degrees to under-ground openness 130 degrees, an output side is set to 0 (black) to 255 (white), and an under-ground openness φi of 50 degrees is converted to “255” while an under-ground openness φi of 130 degrees is converted into “0” (see FIG. 60(c)). However, conversion is performed to “120” to the output when the under-ground openness φi is 90 degrees. Specifically, a look-up table is used. A histogram of under-ground openness obtained by the conversion described above is illustrated in FIG. 59(c).

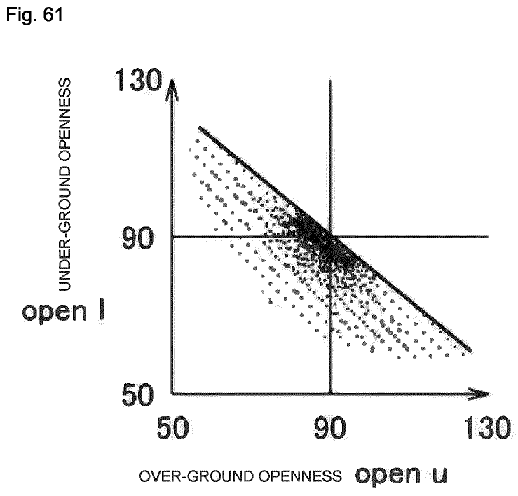

In other words, a relationship between over-ground openness and under-ground openness by the gradient conversion unit is illustrated in FIG. 39 as a scatter diagram. FIG. 61 plots the over-ground openness (50 degrees to 130 degrees) on an axis of abscissa and the under-ground openness (50 degrees to 130 degrees) on an axis of ordinate. The scatter diagram is centered on (90 degrees, 90 degrees). The scatter diagram shows that the closer to the straight line, more blue, the further away from the straight line, more yellow, and even further away, more red.

The color of the plot points indicates a color corresponding to an amount of inclination of a same subject point. As illustrated in FIG. 61, there is an inversely proportional relationship between over-ground openness and under-ground openness. This relationship becomes stronger the shorter the distance. The over-ground openness is large and the under-ground openness is small in ridge areas while the over-ground openness is small and the under-ground openness is large in valley areas.

The color of the plot points indicate that there is a weak proportional relationship between the sum of over-ground openness and under-ground openness and inclination.

### (Channelizing Unit)

Every time the inclination image gradation corrector 62 converts a slope gradient (0 degree to 50 degrees) into a color value (255 to 0), the L* channelizing unit 66 assigns the color value to the L* channel (see FIG. 60(a)).

Every time the over-ground openness image gradation corrector 63 converts an over-ground openness θi (50 degrees to 130 degrees) into a color value (0 to 255), the a* channelizing unit 67 assigns the color value to the a* channel.

Every time an under-ground openness φi (50 degrees to 130 degrees) is converted into a color value (255 to 0), the b* channelizing unit 65 assigns the color value to the b* channel.

The L*a*b* color imaging unit 68 defines L* data of the L* channelizing unit 66, a* data of the a* channelizing unit 67, and b* data of the b* channelizing unit 65 in the L*a*b* space and obtains a L*a*b* color image Li (Lai, Lbi) in a memory 41 (see FIG. 62).

### (Other)

Since the L*a*b* color image Li has a wider color space than the RGB space, the gradation corrector 69 uses a toe curve to perform fine adjustment after approximate color adjustment is performed by level correction.

For example, a slope gradient of 0 degrees to 50 degrees is changed to 0 degree to 30 degrees or 0 degree to 70 degrees to be reassigned a color value. In addition, an over-ground openness (50 degrees to 130 degrees) or an under-ground openness (50 degrees to 130 degrees) is changed to 60 degrees to 120 degrees or 70 degrees to 110 degrees to be reassigned a color value.

The XYZ color system converter 71 converts a Lab adjusted image into the XYZ color system (defines in a color space memory of the XYZ color system) (Lab image of XYZ color system).

The RGB color system converter 70 converts a Lab image in the XYZ color system into the RGB color system (defines in a RGB space memory) (Lab image of RGB layer). The Lab image of the RGB layer is stored in a memory 42.

The Lab synthesizer 340 (image synthesis process) synthesizes (synthesize by multiplication) the Lab color image of the RGB layer in the memory 42 and the super-resolution stereoscopic visualization image Ki (super-resolution red stereoscopic visualization image) and stores the synthesized image as a Lab color red super-resolution image Lki in the memory 172.

The fine tuning corrector 72 adjusts a contrast (transparency) or the like of the Lab color red super-resolution image Lki (by operator input).

In other words, by overlapping and synthesizing these images, the expression of valleys that have become too dark is adjusted and improved to cyanish colors. Therefore, the valley is neither dark nor difficult to see.

### Third Embodiment

The third embodiment represents a method of emphasizing water systems.

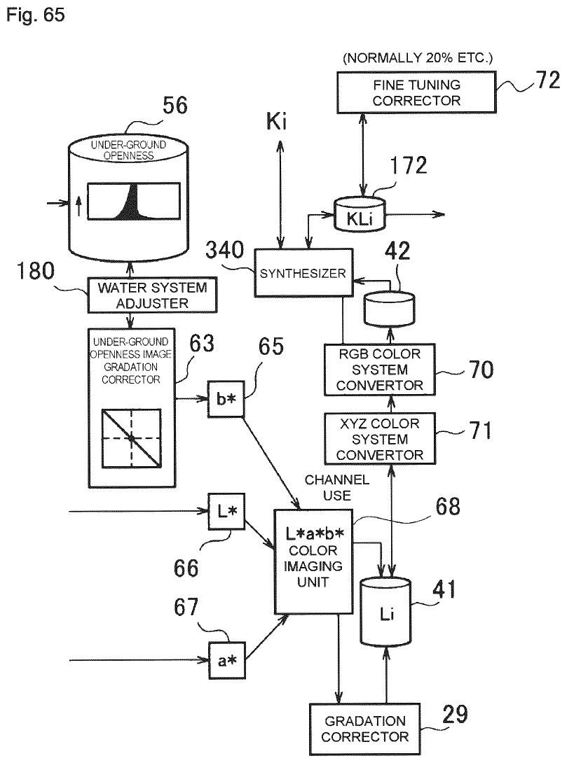

FIG. 65 is a schematic configuration diagram of the third embodiment. Duplicate explanations are omitted for parts denoted by the same reference numerals as described above. As illustrated in FIG. 65, a water system adjuster 180 is provided. The water system adjuster 180 skips the bright side of a histogram of under-ground openness and adjusts an image to be only on the dark side. Accordingly, a portion where under-ground openness is high (portion relatively lower than valley portions or periphery) is extracted.

Then, in a similar manner to the second embodiment, the super-resolution L*a*b* color image Li and the super-resolution stereoscopic visualization image Ki (super-resolution red stereoscopic visualization image) are superimposed.

Note that unlike contour maps and the like, a red relief image map has no concept of height and only expresses unevenness. Therefore, when there is a large difference in elevation within a target area, an overall sense of undulation may not be sufficient. When a large terrain is represented on a red relief image map, this can be achieved by increasing the range of consideration of the degree of openness according to the scale of the represented terrain (in other words, when desiring to see terrain undulations in an area of about 1 km, a range of the degree of openness is set to 1000 m).

However, in practice, the calculation of the degree of openness is regulated by microtopography that exists around a location of interest and the degree of openness of 1 km ahead is seldom calculated.

For example, if a range of the degree of openness such as 1 km is set with respect to 1 m-DEM, the value of the degree of openness will be saturated in valley and ridge portions, causing the valleys to become too dark and the ridges to become too light.

This problem is solved by reducing the resolution of the DEM to be calculated (reducing the resolution of the terrain) and then performing a calculation.

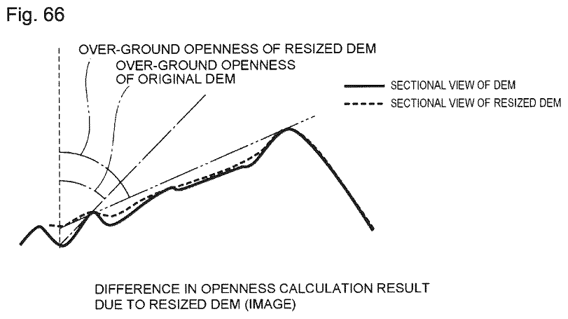

This allows for calculations that take the earth system into account (see FIG. 66).

Between 1 m-DEM and 4 m-DEM, 4 m-DEM provides a stronger sense of undulation as a whole.

In addition, the methods according to the embodiments described above can be applied to the topography of Venus and Mars. Furthermore, it can also be applied to the visualization of unevenness measured with an electron microscope. When applied to gaming devices, it provides a stereoscopic effect without the need for glasses.

While a super-resolution image is generated using an elevation-depression degree (ridge-valley value) obtained from over-ground openness and under-ground openness in the embodiments described above, the super-resolution image may be superimposed and displayed on an image obtained by sky coverage, a topographic protection factor, a plane curvature, a high-pass filter, or a Mexican hat function.

Alternatively, an image can be created by inverting the sky coverage, the topographic protection factor, the plane curvature, the high-pass filter, the Mexican hat function, or the like and the image can be adopted as an under-ground openness image.

Note that the DEM of a base map may be ALB (Airborne lidar Bathymetry) (point cloud density: 1 point/m2).

### REFERENCE SIGNS LIST

110 base map database
112 area definition unit
115 5 m-DEM odd-number divider
136 raster coloring processor
134 moving-average unit
135 super-resolution rasterization processor
137 TIN bilinear interpolation unit
145 plane-rectangular coordinate converter
148 consideration-distance grid-number calculator
151 super-resolution image generator
152 X-direction adjuster

1. A high-speed super-resolution image stereoscopic visualization processing system, comprising:
(A). means of obtaining, for each square mesh of a cluster of square meshes of a predetermined area of a digital elevation model, a super-resolution square mesh by defining the square mesh by a cluster of fine square super-resolution fine meshes;
(B). means of interpolating for each of the super-resolution square meshes and assigning an interpolated elevation-value to each super-resolution fine mesh of the super-resolution square mesh;
(C). means of applying, for each of the super-resolution square meshes, a moving-average process to each super-resolution fine mesh a predetermined number of times, and updating the interpolated elevation-value with a smoothing elevation-value designated after the moving-average process;
(D). means of generating a plane-rectangular super-resolution mesh by defining the super-resolution square mesh after the means (C) by plane-rectangular coordinates; and
(E). means of generating a square super-resolution stereoscopic visualization image based on a plane-rectangular super-resolution fine mesh of the plane-rectangular super-resolution mesh.

2. The high-speed super-resolution image stereoscopic visualization processing system according to claim 1, wherein the means of (E) includes:
(E1). means of generating a square adjustment super-resolution mesh by adjusting the plane-rectangular super-resolution mesh to assume a square;
(E2). means of sequentially designating a square adjustment fine mesh of the square adjustment super-resolution mesh as a subject point, determining a slope gradient with a square adjustment fine mesh adjacent to the designated square adjustment fine mesh based on the smoothing elevation-value, and assigning the slope gradient to the square adjustment fine mesh of the subject point;
(E3). means of sequentially designating the square adjustment fine mesh as a subject point, for each said subject point, determining a ridge-valley value based on an over-ground openness and an under-ground openness between the square adjustment fine mesh of the subject point and the square adjustment fine mesh adjacent to the subject point, and assigning a gradation color value indicating a color value of a combination of the ridge-valley value and the slope gradient to the square adjustment fine mesh of the subject point; and
(E4). after means of (E3), means of defining the square adjustment fine mesh and a gradation color value of the square adjustment fine mesh in a display memory and displaying the square adjustment fine mesh and the gradation color value as the square super-resolution stereoscopic visualization image.

3. The high-speed super-resolution image stereoscopic visualization processing system according to claim 1, comprising:
means of obtaining an over-ground openness image (Dp) to which the larger a value of the over-ground openness, the brighter a color assigned, an under-ground openness image (Dq) to which the larger a value of the under-ground openness, the darker a color assigned, and a slope-gradient emphasis image (Dr) to which the larger a value of slope gradient, the greater the emphasis on red in a color assigned;
means of obtaining a first synthetic image (Ki: super-resolution red image) formed by superimposing the over-ground openness image (Dp), the under-ground openness image (Dq), and the slope-gradient emphasis image (Dr);
means of reading image data of the over-ground openness image (Dp) and obtaining a data assigned to an a* channel for each read;
means of reading image data of the under-ground openness image (Dq) and obtaining b data assigned to a b* channel for each read;
means of reading image data of the slope-gradient emphasis image (Dr) and obtaining L data assigned to an L* channel for each read;
means of obtaining Lab image data (Li) of the over-ground openness image (Dp), the under-ground openness image (Dq), and the slope-gradient emphasis image (Dr) by defining, every time the a data, the b data, and the L data are obtained, the pieces of data in a L*a*b* space; and
means of generating a second synthetic image (lab color super-resolution red image KLi) formed by synthesizing the Lab image (Li) and the first synthetic image (Ki: super-resolution red image).

4. The high-speed super-resolution image stereoscopic visualization processing system according to claim 1, wherein the means of (A) includes:
(A1). means of reading the cluster of square meshes in the predetermined area of the digital elevation-model stored in a digital elevation-model storage into a first memory; and
(A2). means of equally dividing, for each square mesh of the first memory, an edge in a latitudinal direction and an edge in a longitudinal direction of the square mesh by a division point number that is an odd number (not including 1) to generate the super-resolution square mesh having a cluster of the super-resolution fine meshes.

5. The high-speed super-resolution image stereoscopic visualization processing system according to claim 1, wherein the means of (C) includes:
means of reading the smoothing elevation-value of the area into the display memory and displaying as the square super-resolution stereoscopic visualization image on a screen, and when a super-resolution smoothing process instruction is entered, once again performing the super-resolution smoothing process.

6. The high-speed super-resolution image stereoscopic visualization processing system according to claim 1, wherein the means of (C) includes:
(C1). means of sequentially designating the super-resolution square mesh and, for each designated super-resolution square mesh, sequentially designating the super-resolution fine mesh;
(C2). means of applying a moving-average mesh divided by the division point number on the super-resolution fine mesh a predetermined number of times to generate the smoothing elevation-value; and
(C3). means of updating the interpolated elevation-value of the designated super-resolution fine mesh to the smoothing elevation-value after the process by the means of (C2).

7. The high-speed super-resolution image stereoscopic visualization processing system according to claim 1, comprising:
(F). means of designating the plane-rectangular super-resolution fine mesh or a plane-rectangular super-resolution fine mesh to be a point of origin in the square adjustment fine mesh of the step, determining straight lines that pass through a cluster of meshes having a same smoothing elevation-value as the designated mesh and delineating a closed curve, and vectorizing the straight lines to generate contour vectors; and
(G). means of converting the contour vectors into an image, writing the image in the display memory, and causing the image to be displayed on the screen.

8. The high-speed super-resolution image stereoscopic visualization processing system according to claim 1, wherein the color tone of the slope gradient is displayed in a reddish color.

9. A high-speed super-resolution image stereoscopic visualization processing program, causing a computer to execute functions as:
(A). means of generating, for each square mesh of a cluster of square meshes of a predetermined area of a digital elevation model, a super-resolution square mesh by defining the square mesh by a cluster of fine square super-resolution fine meshes in storage means;
(B). means of interpolating for each of the super-resolution square meshes and assigning an interpolated elevation-value to each super-resolution fine mesh of the super-resolution square mesh;
(C). means of applying, for each of the super-resolution square meshes, a moving-average process to each super-resolution fine mesh a predetermined number of times, and updating the interpolated elevation-value with a smoothing elevation-value designated after the moving-average process;
(D). means of generating a plane-rectangular super-resolution mesh by defining the super-resolution square mesh after the means (C) by plane-rectangular coordinates in storage means; and
(E). means of generating a super-resolution stereoscopic visualization image based on a plane-rectangular super-resolution fine mesh of the plane-rectangular super-resolution mesh in storage means.

10. The high-speed super-resolution image stereoscopic visualization processing program according to claim 12, wherein the means of (E) includes:
(E1). means of generating a square adjustment super-resolution mesh by adjusting the plane-rectangular super-resolution mesh to assume a square;
(E2). means of sequentially designating a square adjustment fine mesh of the square adjustment super-resolution mesh as a subject point, determining a slope gradient with a square adjustment fine mesh adjacent to the designated square adjustment fine mesh based on the smoothing elevation-value, and assigning the slope gradient to the square adjustment fine mesh of the subject point;
(E3). means of sequentially designating the square adjustment fine mesh as a subject point, for each said subject point, determining a ridge-valley value between the square adjustment fine mesh of the subject point and the square adjustment fine mesh adjacent to the subject point, and assigning a gradation color value indicating a color value of a combination of the ridge-valley value and the slope gradient to the square adjustment fine mesh of the subject point; and
(E4). after means of (E3), means of defining the square adjustment fine mesh and a gradation color value of the square adjustment fine mesh in a display memory and displaying the square adjustment fine mesh and the gradation color value as the square super-resolution stereoscopic visualization image.

11. The high-speed super-resolution image stereoscopic visualization processing program according to claim 9, wherein the means of (A) includes:
(A1). means of reading the cluster of square meshes in the predetermined area of the digital elevation model stored in a digital elevation model storage into a first memory; and
(A2). means of equally dividing, for each square mesh of the first memory, an edge in a latitudinal direction and an edge in a longitudinal direction of the square mesh by a division point number that is an odd number (not including 1) to generate the super-resolution square mesh having a cluster of the super-resolution fine meshes.

12. The high-speed super-resolution image stereoscopic visualization processing program according to claim 9, wherein the means of (C) includes:
means of reading the smoothing elevation-value of the area into the display memory and displaying as the square super-resolution stereoscopic visualization image on a screen, and when a super-resolution smoothing process instruction is entered, once again performing the super-resolution smoothing process when a super-resolution smoothing process instruction is entered.

13. The high-speed super-resolution image stereoscopic visualization processing program according to claim 9, wherein the means of (C) includes:
(C1). means of sequentially designating the super-resolution square mesh and, for each designated super-resolution square mesh, sequentially designating the super-resolution fine mesh;
(C2). means of applying a moving-average mesh divided by the division point number on the super-resolution fine mesh a predetermined number of times to generate the smoothing elevation-value; and
(C3). means of updating the interpolated elevation-value of the designated super-resolution fine mesh to the smoothing elevation-value after the process by the means of (C2).

14. The high-speed super-resolution image stereoscopic visualization processing program according to claim 9, causing a computer to execute functions as:
(F). means of designating the plane-rectangular super-resolution fine mesh or a plane-rectangular super-resolution fine mesh to be a point of origin in the square adjustment fine mesh of the step, determining straight lines that pass through a cluster of meshes having a same smoothing elevation-value as the designated mesh and delineating a closed curve, and vectorizing the straight lines to generate contour vectors; and
(G). means of converting the contour vectors into an image, writing the image in the display memory, and causing the image to be displayed on the screen.

15. The high-speed super-resolution image stereoscopic visualization processing program according to claim 9, causing a computer to execute functions as:
means of storing, in a standard map memory, 1/25,000 standard map information in which roads, buildings, rivers, and swamps are defined by vector information; and
(H). means of imaging the standard map information and displaying the image as the high-speed super-resolution image or an image of contour vectors or a combination of both.

16. The high-speed super-resolution image stereoscopic visualization processing program according to claim 9, wherein the color tone of the slope gradient is displayed in a reddish color.
